(19) United States
(12) Patent Application Publication
(10) Pub. No.: US 2026/0349366 A1
(43) Pub. Date: Nov. 5, 2026

(54) LIGHT SCANNING APPARATUS AND IMAGE FORMING APPARATUS INCLUDING THE SAME

(71) Applicant: CANON KABUSHIKI KAISHA, Tokyo (JP)

(72) Inventors: TOSHIFUMI CHIDA, Tochigi (JP); YUICHI TOMIOKA, Tochigi (JP); MASAYASU TERAMURA, Osaka (JP)

(21) Appl. No.: 19/438,085

(22) Filed: Dec. 31, 2025

(30) Foreign Application Priority Data
Jan. 9, 2025 (JP) 2025-003304

(51) Int. Cl. G03G 15/04; G02B 1/11; G02B 26/10; G02B 26/12

(52) U.S. Cl. CPC G03G 15/0409; G02B 26/105; G02B 26/123; G02B 1/11

(57) ABSTRACT

An apparatus according to the disclosure includes a deflecting unit including first and second deflecting surfaces configured to deflect first and second light fluxes to scan first and second surfaces in a main scanning direction, and first and second optical systems configured to guide the first and second light fluxes deflected by the first and second deflecting surfaces to the first and second surfaces. Scanning speeds of the first light flux at an on-axis image height and an outermost off-axis image height on the first surface are different from each other. The first optical system consists of a first optical element in which a sagittal line tilt amount on at least one of an incident surface and an exit surface thereof changes in a main scanning direction.

### BACKGROUND

### Field of the Technology

The aspect of the embodiments is related to a light scanning apparatus and an image forming apparatus including the light scanning apparatus.

### Description of the Related Art

Conventionally, there is a light scanning apparatus including a deflecting unit configured to deflect first and second light fluxes to scan first and second surfaces to be scanned, respectively, and first and second optical systems configured to guide the first and second light fluxes deflected by first and second deflecting surfaces of the deflecting unit to the first and second surfaces to be scanned, respectively.

In such light scanning apparatus, it is known that ghost light generated by a reflection of the first light flux on a predetermined optical surface in the first optical system reaches the second surface to be scanned, which may degrade a quality of an image formed on the second surface to be scanned.

Japanese Patent Laid-Open No. 2018-124325 discloses a light scanning apparatus in which an optical element closest to a deflecting unit of a first optical system is provided with an optical surface formed as a sagittal line tilt changing surface in which a tilt amount in a sub-scanning cross section changes in a main scanning direction, thereby suppressing ghost light from reaching the second surface to be scanned.

In the light scanning apparatus, scanning speeds of the first and second light fluxes on the first and second surfaces to be scanned are constant, and a fine structure grating is formed on the optical surface.

### SUMMARY

An apparatus includes a deflecting unit including first and second deflecting surfaces configured to deflect first and second light fluxes to scan first and second surfaces in a main scanning direction, and first and second optical systems configured to guide the first and second light fluxes deflected by the first and second deflecting surfaces to the first and second surfaces. Scanning speeds of the first light flux at an on-axis image height and an outermost off-axis image height on the first surface are different from each other. The first optical system includes of a first optical element in which a sagittal line tilt amount on at least one of an incident surface and an exit surface thereof changes in a main scanning direction.

Features of the disclosure will become apparent from the following description of embodiments with reference to the attached drawings. The following description of embodiments is described by way of example.

### BRIEF DESCRIPTION OF THE DRAWINGS

FIG. 1A is a developed view in a main scanning cross section of a light scanning apparatus according to a first embodiment of the disclosure.

FIG. 1B is a partial sub-scanning cross sectional view of the light scanning apparatus according to the first embodiment.

FIG. 2 is a graph showing scanning speeds at respective image heights on first and second surfaces to be scanned by the light scanning apparatus according to the first embodiment.

FIG. 3A is a partial sub-scanning cross sectional view showing a state in which opposite side ghost travels in a light scanning apparatus of a comparative example.

FIG. 3B is a partial sub-scanning cross sectional view showing a state in which opposite side ghost travels in the light scanning apparatus of the comparative example.

FIG. 4A is a partial sub-scanning cross sectional view showing a state in which opposite side ghost travels in the light scanning apparatus according to the first embodiment.

FIG. 4B is a partial sub-scanning cross sectional view showing a state in which opposite side ghost travels in the light scanning apparatus according to the first embodiment.

FIG. 5A is a graph showing light amounts of opposite-side ghosts at respective image heights on the second surface to be scanned by the light scanning apparatus according to the first embodiment.

FIG. 5B is a graph showing light amounts of opposite-side ghosts at respective image heights on the second surface to be scanned by the light scanning apparatus according to the first embodiment.

FIG. 6A is a graph showing a positional dependence in a main scanning direction of a sagittal line tilt angle of an incident surface of a first imaging optical element provided in the light scanning apparatus according to the first embodiment.

FIG. 6B is a graph showing a positional dependence in the main scanning direction of the sagittal line tilt angle of an exit surface of the first imaging optical element provided in the light scanning apparatus according to the first embodiment.

FIG. 7A is a graph showing magnitudes of irradiation positions in a sub-scanning direction at respective image heights on the first surface to be scanned by the light scanning apparatus according to the first embodiment.

FIG. 7B is a graph showing magnitudes of 45ASs at respective image heights on the first surface to be scanned by the light scanning apparatus according to the first embodiment.

FIG. 8A is a graph showing a positional dependence in the main scanning direction of a sagittal line tilt angle of an incident surface of a first imaging optical element provided in a light scanning apparatus according to a second embodiment of the disclosure.

FIG. 8B is a graph showing a positional dependence in the main scanning direction of a sagittal line tilt angle of an exit surface of the first imaging optical element provided in the light scanning apparatus according to the second embodiment.

FIG. 9A is a graph showing light amounts of opposite-side ghosts at respective image heights on the second surface to be scanned by the light scanning apparatus according to the second embodiment.

FIG. 9B is a graph showing light amounts of opposite-side ghosts at respective image heights on the second surface to be scanned by the light scanning apparatus according to the second embodiment.

FIG. 10A is a graph showing magnitudes of irradiation positions in the sub-scanning direction at respective image heights on the first surface to be scanned by the light scanning apparatus according to the second embodiment.

FIG. 10B is a graph showing magnitudes of 45ASs at respective image heights on the first surface to be scanned by the light scanning apparatus according to the second embodiment.

FIG. 11A is a graph showing a positional dependence in the main scanning direction of a sagittal line tilt angle of an incident surface of a first imaging optical element provided in a light scanning apparatus according to a third embodiment of the disclosure.

FIG. 11B is a graph showing a positional dependence in the main scanning direction of a sagittal line tilt angle of an exit surface of the first imaging optical element provided in the light scanning apparatus according to the third embodiment.

FIG. 12A is a graph showing light amounts of opposite-side ghosts at respective image heights on the second surface to be scanned by the light scanning apparatus according to the third embodiment.

FIG. 12B is a graph showing light amounts of opposite-side ghosts at respective image heights on the second surface to be scanned by the light scanning apparatus according to the third embodiment.

FIG. 13A is a graph showing magnitudes of irradiation positions in the sub-scanning direction at respective image heights on the first surface to be scanned by the light scanning apparatus according to the third embodiment.

FIG. 13B is a graph showing magnitudes of 45ASs at respective image heights on the first surface to be scanned by the light scanning apparatus according to the third embodiment.

FIG. 14 is a sub-scanning cross sectional view of a main part of an image forming apparatus according to the disclosure.

### DESCRIPTION OF THE EMBODIMENTS

Hereinafter, a light scanning apparatus according to the disclosure is described in detail with reference to the accompanying drawings. Note that drawings described below may be drawn on a scale different from the actual scale in order to facilitate understanding of the disclosure.

In the following description, the main scanning direction is a direction perpendicular to a rotation axis 4c of a polygon mirror 4 and an optical axis of an imaging optical system (a direction in which a light flux is deflected by the polygon mirror 4), and the sub-scanning direction is a direction parallel to the rotation axis 4c of the polygon mirror 4.

Further, the main scanning cross section is a cross section perpendicular to the sub-scanning direction, and the sub-scanning cross section is a cross section perpendicular to the main scanning direction.

Furthermore, a direction parallel to the optical axis of the imaging optical system, the main scanning direction, and the sub-scanning direction are defined as an X direction, a Y direction, and a Z direction, respectively.

The origin of coordinates in the light scanning apparatus according to the disclosure is set at a position of a center of the polygon mirror 4.

A positive side and a negative side in the X direction are referred to as a main light side and an opposite side, respectively.

### First Embodiment

Conventionally, there is known an image forming apparatus, such as a printer or a copier, equipped with a light scanning apparatus in which a plurality of imaging optical systems for respectively scanning a plurality of surfaces to be scanned are provided in a single housing in order to simultaneously scan the plurality of surfaces to be scanned.

In such light scanning apparatus, the surface to be scanned is generally scanned at a constant speed in a main scanning direction.

On the other hand, in order to reduce a size of an imaging optical element, a light scanning apparatus having a characteristic in which scanning speeds at off-axis image heights are higher than a scanning speed at an on-axis image height on the surface to be scanned has been proposed.

In addition, conventionally, a light scanning apparatus has been proposed in which an imaging optical system is provided on each of both sides of a deflecting unit in order to scan a plurality of surfaces to be scanned, and a plurality of incident optical systems are provided in the same plane parallel to a main scanning cross section in order to reduce a thickness.

In such in-deflection-plane both-side scanning type light scanning apparatus, it is known that ghost light generated by reflection of a light flux incident on an imaging optical element provided in an imaging optical system on one side may reach a surface to be scanned on the other side.

In the conventional light scanning apparatus, a sagittal line tilt changing surface is provided in the imaging optical element in order to suppress ghost light from reaching the surface to be scanned.

That is, the sagittal line tilt changing surface is an optical surface in which a normal line is inclined with respect to the main scanning cross section including the optical axis in the sub-scanning cross section, and an angle formed by the normal line and the main scanning cross section in the sub-scanning cross section, namely a sagittal line tilt amount changes according to a position in the main scanning direction.

In addition, in the above-described conventional light scanning apparatus, a fine structure grating is formed on the optical surface of the imaging optical element in place of the coating in order to reduce a light amount of ghost light.

However, in the above-described conventional light scanning apparatus, although the fine structure grating is formed on the optical surface of the imaging optical element in order to reduce the light amount of ghost light, a degree of technical difficulty of transferring such fine structure grating to the optical surface in a mold molding is very high.

In particular, since a required accuracy for controlling a size of each concave portion in the fine structure grating is also high, a cost of the mold also increases.

Further, even when the coating or the fine structure grating is provided on the optical surface, it is difficult to set a reflectivity of the optical surface to zero due to a manufacturing error. Therefore, it is difficult to sufficiently reduce light amount of ghost light reaching the surface to be scanned on the other side according to downsizing.

Accordingly, an object of the disclosure is to provide a light scanning apparatus capable of reducing ghost light at low cost even when in-deflection-plane both-side scanning type is employed. Thereby, it is possible to provide a low-cost and thin light scanning apparatus.

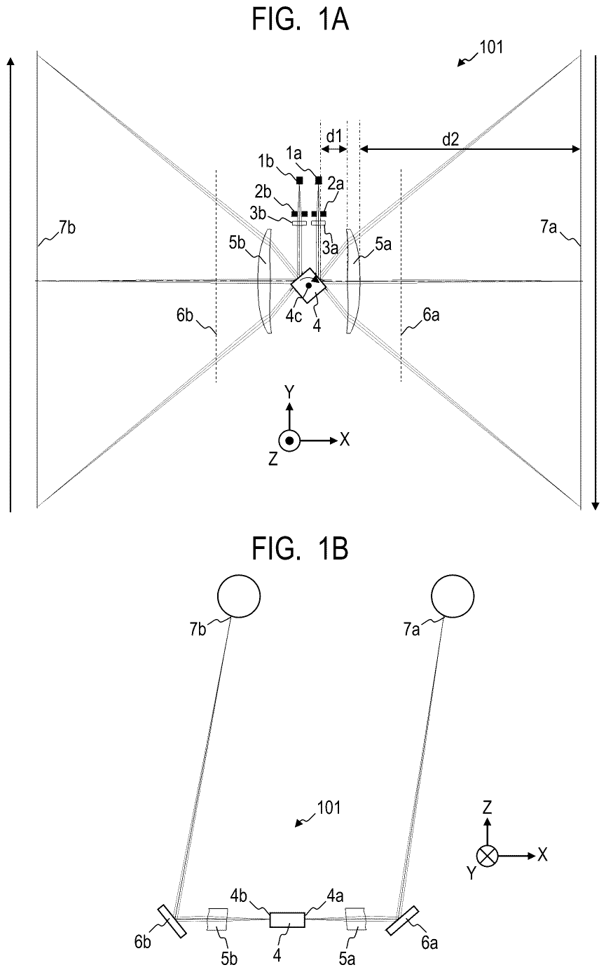

FIG. 1A and FIG. 1B show a schematic developed view in a main scanning cross section and a partial schematic sub-scanning cross sectional view of a light scanning apparatus 101 according to a first embodiment of the disclosure, respectively.

The light scanning apparatus 101 according to the embodiment includes first and second light sources 1a and 1b, first and second stops 2a and 2b, first and second anamorphic lenses 3a and 3b, a polygon mirror 4 (deflecting unit), and first and second imaging optical systems. The first imaging optical system includes a first imaging optical element 5a (first optical element), and the second imaging optical system includes a second imaging optical element 5b (second optical element), in the embodiment.

Further, the light scanning apparatus 101 according to the embodiment includes first and second folding mirrors 6a and 6b, and is configured to scan first and second surfaces to be scanned 7a and 7b in the main scanning direction by rotating the polygon mirror 4 at a constant speed.

The above-described optical elements are accommodated in a housing (not shown).

The light scanning apparatus 101 according to the embodiment employs a both-side scanning type which scans the first and second surfaces to be scanned 7a and 7b that are arranged on opposite sides of the polygon mirror 4.

Specifically, the light scanning apparatus 101 according to the embodiment scans the first and second surfaces 7a and 7b which are arranged on sides opposite to each other with respect to a plane which includes a rotation axis of the polygon mirror 4 and is perpendicular to optical axes of the first and second imaging optical systems.

Therefore, in the light scanning apparatus 101 according to the embodiment, the first and second imaging optical elements 5a and 5b are arranged on the sides opposite to each other with respect to the plane.

The first and second light sources 1a and 1b are formed by end surface emitting type laser elements that emit first and second light fluxes having wavelengths of 780 nm, have a single light emitting point, and are provided on a substrate (not shown).

Each of the first and second light sources 1a and 1b is not limited to a laser element, and may be formed by a light emitting diode (LED).

Further, each of the first and second light sources 1a and 1b is not limited to the end surface emitting type laser element, and may be formed by a vertical cavity surface emitting laser (VCSEL).

Furthermore, the first and second light sources 1a and 1b may be configured to emit the first and second light fluxes having wavelengths other than 780 nm, respectively.

In addition, each of the first and second light sources 1a and 1b is not limited to a single light emitting point, and may have a plurality of light emitting points.

The first and second stops 2a and 2b are configured to limit light flux diameters in the main scanning direction and the sub-scanning direction of the first and second light fluxes emitted from the first and second light sources 1a and 1b, respectively, and are formed integrally with the housing (not shown).

Specifically, opening portions provided in the first and second stops 2a and 2b have elliptical shapes whose widths in the main scanning direction and the sub-scanning direction are different from each other.

Each of the first and second stops 2a and 2b is not limited to the opening portion in elliptical shape, and may have the opening portion in circular shape.

The first and second anamorphic lenses 3a and 3b are configured to convert the first and second light fluxes having passed through the first and second stops 2a and 2b into parallel light fluxes in the main scanning cross section, respectively. The parallel light flux includes not only a strictly parallel light flux but also a substantially parallel light flux such as a weakly divergent light flux or a weakly convergent light flux.

Further, the first and second anamorphic lenses 3a and 3b are configured to condense the first and second light fluxes having passed through the first and second stops 2a and 2b in the vicinity of first and second deflecting surfaces 4a and 4b of the polygon mirror 4 in the sub-scanning cross section, respectively.

In the light scanning apparatus 101 according to the embodiment, by using the first and second anamorphic lenses 3a and 3b, it is possible to perform imaging by the first and second light fluxes by a power in the main scanning cross section and that in the sub-scanning cross section which are different from each other by a single lens.

The first and second anamorphic lenses 3a and 3b provided in the light scanning apparatus 101 according to the embodiment are formed by a resin material, specifically ZEONEX® K22R (Zeon Corporation).

Further, in the light scanning apparatus 101 according to the embodiment, a combination of a collimator lens and a cylinder lens may be provided instead of each of the first and second anamorphic lenses 3a and 3b.

In the light scanning apparatus 101 according to the embodiment, a first incident optical system (third optical system) is formed by the first stop 2a and the first anamorphic lens 3a, and a second incident optical system is formed by the second stop 2b and the second anamorphic lens 3b.

The first and second light fluxes emitted from the first and second light sources 1a and 1b are guided onto the first and second deflecting surfaces 4a and 4b of the polygon mirror 4 by the first and second incident optical systems, respectively.

The polygon mirror 4 has four deflecting surfaces, and is formed by a rotary polygon mirror that deflects the incident first and second light fluxes by first and second deflecting surfaces 4a and 4b, respectively, with rotating around a rotation axis 4c at a constant speed.

The polygon mirror 4 is not limited to the rotary polygon mirror, and may be formed by MEMS (Micro Electro Mechanical Systems) that performs reciprocating scanning, and the number of deflecting surfaces is not limited to four.

The first and second imaging optical elements 5a and 5b are configured to guide (condense) the first and second light fluxes deflected by the polygon mirror 4 to respective image heights between outermost off-axis image heights on the first and second surfaces to be scanned 7a and 7b, respectively.

Specifically, each of the first and second imaging optical elements 5a and 5b provided in the light scanning apparatus 101 according to the embodiment is formed by a resin material, specifically ZEONEX® K22R (Zeon Corporation).

The first and second imaging optical elements 5a and 5b may be formed by a material other than the above-mentioned resin material.

Further, each of the first and second imaging optical elements 5a and 5b is composed of a single optical element (lens).

Here, the “optical element” means a single optical element (minimum unit of the optical element) which is integrally formed, and does not include a set of a plurality of optical elements.

For example, when there are two optical elements arranged on opposite sides with respect to the sub-scanning cross section including the rotation axis of the polygon mirror 4, in other words, when the two optical elements are arranged adjacent to each other in the main scanning direction, the two optical elements cannot be collectively referred to as the “single optical element”.

If necessary, each optical element may be a prism or the like other than a lens.

In the light scanning apparatus 101 according to the embodiment, while the polygon mirror 4 rotates at a constant speed, the first and second imaging optical elements 5a and 5b have a power in the main scanning cross section so as to scan the first and second surfaces to be scanned 7a and 7b at a non-constant speed, respectively.

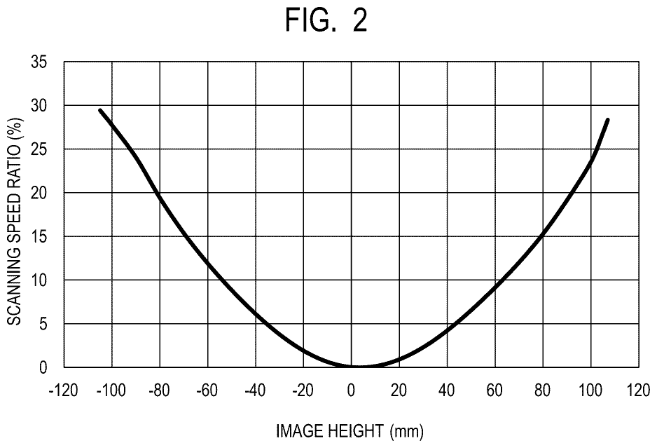

FIG. 2 shows values of ratios of scanning speeds at respective image heights to scanning speeds at on-axis image heights on the first and second surfaces to be scanned 7a and 7b by the light scanning apparatus 101 according to the embodiment.

In FIG. 2, a value obtained by subtracting 1 from the value of the ratio at each image height is shown.

As shown in FIG. 2, shapes (meridional line shapes) in the main scanning cross section of the first and second imaging optical elements 5a and 5b are set such that the scanning speed at the outermost off-axis image heights is about 1.3 times as high as the scanning speed at the on-axis image height in the light scanning apparatus 101 according to the embodiment.

Thereby, it is possible to shorten optical path lengths between on-axis deflection points on the first and second deflecting surfaces 4a and 4b and the first and second surfaces to be scanned 7a and 7b, compared to conventional light scanning apparatuses that scan a surface to be scanned at a constant speed in the light scanning apparatus 101 according to the embodiment.

The on-axis deflection points are deflection points on the first and second deflecting surfaces 4a and 4b of the polygon mirror 4 with respect to principal rays of the first and second light fluxes (hereinafter referred to as on-axis light fluxes) when scanning the on-axis image heights of the first and second surfaces to be scanned 7a and 7b.

In addition, in the light scanning apparatus 101 according to the embodiment, the first and second imaging optical elements 5a and 5b can be arranged closer to the polygon mirror 4, compared to the conventional light scanning apparatuses by providing the first and second imaging optical elements 5a and 5b formed as described above.

Thereby, it is possible to reduce volumes of the first and second imaging optical elements 5a and 5b to achieve downsizing and cost reduction.

On the other hand, lateral elongation occurs at off-axis image heights as compared with the on-axis image height in images formed on the first and second surfaces to be scanned 7a and 7b by the non-uniform speed scanning as described above.

Such deterioration in image quality can be suppressed by performing pixel correction according to a position of the image height.

Further, in the light scanning apparatus 101 according to the embodiment, the first and second light fluxes that have passed through the first and second imaging optical elements 5a and 5b, respectively, are condensed on the first and second surfaces to be scanned 7a and 7b in a state where a wave aberration is appropriately corrected, respectively.

In the light scanning apparatus 101 according to the embodiment, the first imaging optical element 5a constitutes a first imaging optical system (first optical system), and the second imaging optical element 5b constitutes a second imaging optical system (second optical system). However, if necessary, each imaging optical system may be constituted by a plurality of optical elements arranged in an optical axis direction.

The first and second light fluxes deflected by the first and second deflecting surfaces 4a and 4b of the polygon mirror 4 are guided onto the first and second surfaces to be scanned 7a and 7b by the first and second imaging optical systems, respectively.

The first and second folding mirrors 6a and 6b reflect the first and second light fluxes so as to bend optical paths of the first and second light fluxes having passed through the first and second imaging optical elements 5a and 5b toward the first and second surfaces to be scanned 7a and 7b, respectively.

Further, the light scanning apparatus 101 according to the embodiment is also provided with a synchronization detection optical system (not shown) that guides a predetermined light flux to a synchronization detection means (not shown) for determining writing start timing on each of the first and second surfaces to be scanned 7a and 7b.

Specification values of the light scanning apparatus 101 according to the embodiment are shown in the following Table 1.

In Table 1, descriptions of the second incident optical system and the second imaging optical system are omitted since configurations of the second incident optical system and the second imaging optical system are the same as those of the first incident optical system and the first imaging optical system.

TABLE 1

| | Arrangement | | |
|---|---|---|---|
| First | Wavelength of first light flux emitted from first light | (nm) | 780 |
| incident | source 1a | | |
| optical | Number of light emitting points of first light source 1a | | 1 |
| system | Distance between light emitting point of first light | (mm) | 14.11 |
| 75a | source 1a and first stop 2a | | |
| | Distance between first stop 2a and first anamorphic | (mm) | 3.7 |
| | lens 3a | | |
| | Thickness of first anamorphic lens 3a | (mm) | 2 |
| | Refractive index of first anamorphic lens 3a | | 1.524 |
| | Curvature radius in main scanning cross section of | (mm) | ∞ |
| | incident surface of first anamorphic lens 3a | | |
| | Curvature radius in sub-scanning cross section of | (mm) | ∞ |
| | incident surface of first anamorphic lens 3a | | |
| | Curvature radius in main scanning cross section of | (mm) | −41.519 |
| | exit surface of first anamorphic lens 3a | | |
| | Curvature radius in sub-scanning cross section of exit | (mm) | 12.483 |
| | surface of first anamorphic lens 3a | | |
| | Distance between exit surface of first anamorphic lens | (mm) | 26.67 |
| | 3a and on-axis deflection point on deflecting surface | | |
| | 4a of polygon mirror 4 | | |
| First | Distance (d1) between on-axis deflection point on | (mm) | 13.8 |
| imaging | deflecting surface 4a of polygon mirror 4 and incident | | |
| optical | surface of first imaging optical element 5a | | |
| system | Thickness of first imaging optical element 5a | (mm) | 6 |
| 85a | Distance (d2) between exit surface of first imaging | (mm) | 105.2 |
| | optical element 5a and first surface to be scanned 7a | | |
| | Refractive index of first imaging optical element 5a | | 1.524 |
| | Distance between on-axis deflection point on | (mm) | 125 |
| | deflecting surface 4a of polygon mirror 4 and first | | |
| | surface to be scanned 7a | | |
| Light | Focal length (on-axis fθ coefficient) of first imaging | (mm/rad) | 109 |
| scanning | optical element 5a | | |
| apparatus | Maximum scanning angle | (degrees) | ±25.5 |
| 101 | Position (Ymax) in main scanning direction of | (mm) | ±107 |
| | outermost off-axis image height | | |
| | Angle between optical axis of first incident optical | (degrees) | 90 |
| | system 75a and optical axis of first imaging optical | | |
| | system 85a | | |
| | Number of deflecting surface 4a of polygon mirror 4 | | 4 |
| | Circumscribed radius of polygon mirror 4 | (mm) | 20 |
| | (X, Y, Z) coordinates of rotation center of polygon | (mm) | (0, 0, 0) |
| | mirror 4 | | |
| | (X, Y) coordinates of reflection point of first folding | (mm) | (5.89, −4.11) |
| | mirror 6a for principal ray of on-axis light flux | | |
| | (X, Y) coordinates of reflection point of second | (mm) | (−5.89, −4.11) |
| | folding mirror 6b for principal ray of on-axis light | | |
| | flux | | |

Next, specific shapes of the first and second imaging optical elements 5a and 5b provided in the light scanning apparatus 101 according to the embodiment are described.

First, a conventional imaging optical element in which each of an incident surface and an exit surface is not formed as a tilt surface in the sub-scanning cross section is considered.

For example, such imaging optical element is used in a light scanning apparatus of an in-deflection-plane incident type in which a light flux is perpendicularly incident on a deflecting surface of a polygon mirror in order to achieve a reduction in thickness.

In such light scanning apparatus, specular reflected light generated by specular reflection of an on-axis light flux incident on the incident surface or the exit surface of the imaging optical element returns to a light source, which may cause an operation failure in the light source.

Further, with respect to a light flux (hereinafter referred to as an off-axis light flux) for scanning an off-axis image height of a surface to be scanned, reflected light reflected by the incident surface or the exit surface of the imaging optical element provided on one of a main light side and an opposite side may reach a surface to be scanned provided on the other side as ghost light.

Then, when such ghost light (hereinafter, referred to as opposite-side ghost) reaches the surface to be scanned, a bright and dark pattern along the main scanning direction is formed in an image formed on the surface to be scanned, thereby an image quality deteriorates.

In the light scanning apparatus 101 according to the embodiment, shapes (sagittal line shapes) in the sub-scanning cross section of the first and second imaging optical elements 5a and 5b are characteristically formed in order to suppress such arrival of the ghost light at the surface to be scanned.

Thereby, it is possible to suppress an increase in size and cost of the light scanning apparatus 101 according to the embodiment.

Numerical values for shapes of an incident surface and an exit surface of the first imaging optical element 5a provided in the light scanning apparatus 101 according to the embodiment are shown in the following Tables 2 and 3.

Since shapes of an incident surface and an exit surface of the second imaging optical element 5b are the same as the shapes of the incident surface and the exit surface of the first imaging optical element 5a, the description thereof is omitted.

TABLE 2

| Main scanning cross section | | | Sub-scanning cross section | | | |
|---|---|---|---|---|---|---|
| (Meridional line shape) | | | (Sagittal line shape) | | | |
| | Scanning | Scanning | Sagittal | | Sagittal | |
| | start side | end side | line R | | line tilt | |
| RY | 9.827.E+01 | 9.827.E+01 | rZ | 3.055.E+01 | M0_1 | −7.000.E−02 |
| KY | −1.124.E+01 | | E1 | 1.112.E−03 | M1_1 | 2.225.E−04 |
| B1 | 0.000.E+00 | 0.000.E+00 | E2 | −1.375.E−04 | M2_1 | 2.770.E−04 |
| B2 | 0.000.E+00 | 0.000.E+00 | E3 | −9.454.E−06 | M3_1 | −2.769.E−06 |
| B3 | 2.772.E−06 | 2.772.E−06 | E4 | 3.029.E−07 | M4_1 | −1.097.E−06 |
| B4 | −2.308.E−05 | −2.375.E−05 | E5 | 8.545.E−09 | M5_1 | 2.030.E−08 |
| B5 | 0.000.E+00 | 0.000.E+00 | E6 | 2.498.E−10 | M6_1 | 1.568.E−09 |
| B6 | 4.554.E−08 | 4.594.E−08 | E7 | 0.000.E+00 | M7_1 | −4.750.E−11 |
| B7 | 0.000.E+00 | 0.000.E+00 | E8 | 0.000.E+00 | M8_1 | −1.064.E−12 |
| B8 | −4.554.E−11 | −4.201.E−11 | E9 | 0.000.E+00 | M9_1 | 4.042.E−14 |
| B9 | 0.000.E+00 | 0.000.E+00 | E10 | 0.000.E+00 | M10_1 | 0.000.E+00 |
| B10 | 1.497.E−14 | 1.431.E−14 | E11 | 0.000.E+00 | M11_1 | 0.000.E+00 |
| B11 | 0.000.E+00 | 0.000.E+00 | E12 | 0.000.E+00 | M12_1 | 0.000.E+00 |
| B12 | 0.000.E+00 | 0.000.E+00 | E13 | 0.000.E+00 | M13_1 | 0.000.E+00 |
| B13 | 0.000.E+00 | 0.000.E+00 | E14 | 0.000.E+00 | M14_1 | 0.000.E+00 |
| B14 | 0.000.E+00 | 0.000.E+00 | E15 | 0.000.E+00 | M15_1 | 0.000.E+00 |
| B15 | 0.000.E+00 | 0.000.E+00 | E16 | 0.000.E+00 | M16_1 | 0.000.E+00 |
| B16 | 0.000.E+00 | 0.000.E+00 | | | | |

TABLE 3

| Main scanning cross section | | | Sub-scanning cross section | | | |
|---|---|---|---|---|---|---|
| (Meridional line shape) | | | (Sagittal line shape) | | | |
| | Scanning | Scanning | Sagittal | | Sagittal | |
| | start side | end side | line R | | line tilt | |
| RY | −1.766.E+02 | −1.766.E+02 | rZ | −1.000.E+01 | M0_1 | −7.860.E−02 |
| KY | 4.169.E+01 | | E1 | 4.032.E−04 | M1_1 | 9.218.E−05 |
| B1 | 0.000.E+00 | 0.000.E+00 | E2 | 1.711.E−04 | M2_1 | 1.233.E−04 |
| B2 | 0.000.E+00 | 0.000.E+00 | E3 | −2.378.E−06 | M3_1 | −4.871.E−07 |
| B3 | 1.250.E−05 | 1.250.E−05 | E4 | −6.593.E−07 | M4_1 | −2.566.E−07 |
| B4 | −1.048.E−05 | −9.749.E−06 | E5 | −4.445.E−09 | M5_1 | 3.848.E−09 |
| B5 | 0.000.E+00 | 0.000.E+00 | E6 | 1.191.E−09 | M6_1 | −2.610.E−10 |
| B6 | 7.356.E−10 | 5.126.E−10 | E7 | 0.000.E+00 | M7_1 | 6.230.E−12 |
| B7 | 0.000.E+00 | 0.000.E+00 | E8 | 0.000.E+00 | M8_1 | 0.000.E+00 |
| B8 | 2.078.E−11 | 1.736.E−11 | E9 | 0.000.E+00 | M9_1 | −7.624.E−15 |
| B9 | 0.000.E+00 | 0.000.E+00 | E10 | 0.000.E+00 | M10_1 | 0.000.E+00 |
| B10 | −1.895.E−14 | −1.027.E−14 | E11 | 0.000.E+00 | M11_1 | 0.000.E+00 |
| B11 | 0.000.E+00 | 0.000.E+00 | E12 | 0.000.E+00 | M12_1 | 0.000.E+00 |
| B12 | 0.000.E+00 | 0.000.E+00 | E13 | 0.000.E+00 | M13_1 | 0.000.E+00 |
| B13 | 0.000.E+00 | 0.000.E+00 | E14 | 0.000.E+00 | M14_1 | 0.000.E+00 |
| B14 | 0.000.E+00 | 0.000.E+00 | E15 | 0.000.E+00 | M15_1 | 0.000.E+00 |
| B15 | 0.000.E+00 | 0.000.E+00 | E16 | 0.000.E+00 | M16_1 | 0.000.E+00 |
| B16 | 0.000.E+00 | 0.000.E+00 | | | | |

In Tables 2 and 3, “E-x” means “×10^{-x}”.

A meridional line shape of each of the incident surface and the exit surface of the first imaging optical element 5a provided in the light scanning apparatus 101 according to the embodiment has an aspherical shape as expressed by the following Expression (1):

$$X = \frac{\frac{{Y}^{2}}{{R}_{Y}}}{1 + \sqrt{1 - ( 1 + {K}_{Y} ) {( \frac{Y}{{R}_{Y}} )}^{2}}} + {\sum }_{i = 1}^{16} {B}_{i} {Y}^{i} . \qquad ( 1 )$$

In Expression (1), R_{Y} is a curvature radius (curvature radius of meridional line) in the main scanning cross section, and K_{Y} and Bi (i=1, 2, . . . , 16) are aspherical coefficients.

As shown in Tables 2 and 3, some values of the aspherical coefficients Bi are different between a scanning start side and a scanning end side.

Further, sagittal line shape of each of the incident surface and the exit surface of the first imaging optical element 5a provided in the light scanning apparatus 101 according to the embodiment has an aspherical shape as expressed by the following Expression (2):

$$S = \frac{\frac{{Z}^{2}}{r}}{1 + \sqrt{1 - ( 1 + {K}_{Z} ) {( \frac{Z}{r} )}^{2}}} + {\sum }_{k = 1}^{1} {\sum }_{j = 0}^{16} {M}_{j \_ k} {Y}^{j} {Z}^{k} . \qquad ( 2 )$$

In Expression (2), S is a sagittal line shape defined in a cross section which includes a normal line of a meridional line at each position on the meridional line and is perpendicular to the main scanning cross section, and K_{Z} and M_{j_k} (j=0, 1, 2, . . . , 16, k=1) are aspherical coefficients.

Note that K_{Z} is set to 0 for each of the incident surface and the exit surface of the first imaging optical element 5a provided in the light scanning apparatus 101 according to the embodiment.

Further, a curvature radius (curvature radius of sagittal line) r in the sub-scanning cross section in Expression (2) varies according to a position Y in the main scanning direction as expressed by the following Expression (3):

$$\frac{1}{r} = \frac{1}{{r}_{Z}} + {\sum }_{l = 1}^{16} {E}_{l} {Y}^{l} . \qquad ( 3 )$$

In Expression (3), r_{Z} is the curvature radius of sagittal line on the optical axis, and Eₗ (l=1, 2, . . . , 16) is a variation coefficient.

The aspherical coefficients M_{j_k} have values as shown in Tables 2 and 3 for the incident surface and the exit surface of the first imaging optical element 5a provided in the light scanning apparatus 101 according to the embodiment.

That is, a tilt angle changes according to the position Y in the main scanning direction on each of the incident surface and the exit surface of the first imaging optical element 5a provided in the light scanning apparatus 101 according to the embodiment.

In other words, both of the incident surface and the exit surface of the first imaging optical element 5a provided in the light scanning apparatus 101 according to the embodiment are formed as sagittal line tilt changing surfaces.

Thereby, since it is possible to generate the opposite side ghost so as to be incident on outside of an effective region of the imaging optical element provided on the opposite side, it is possible to suppress the opposite side ghost from reaching the surface to be scanned on the opposite side.

In this case, since the light scanning apparatus 101 according to the embodiment has a configuration as shown in FIG. 1B, in one embodiment, the opposite side ghost is generated so as to travel on the negative side in the Z direction.

Further, it is possible to achieve both of a reduction of a wave aberration at respective image heights on the first surface to be scanned 7a and suppression of deviation (scanning line curvature) of an irradiation position in the sub-scanning direction by forming each of the incident surface and the exit surface of the first imaging optical element 5a as the sagittal line tilt changing surface.

In addition, the first and second imaging optical systems are constituted by the single first and second imaging optical elements 5a and 5b, respectively to achieve cost reduction in the light scanning apparatus 101 according to the embodiment.

Here, the distance between the on-axis deflection point on the first deflecting surface 4a of the polygon mirror 4 and the incident surface of the first imaging optical element 5a and that between the exit surface of the first imaging optical element 5a and the first surface to be scanned 7a on the optical axis of the first imaging optical system are represented by d₁ and d₂, respectively.

At this time, in the light scanning apparatus 101 according to one embodiment, the following Inequality (4) be satisfied:

$$0.09 < \frac{{d}_{1}}{{d}_{1} + {d}_{2}} < 0.14 . \qquad ( 4 )$$

In the light scanning apparatus 101 according to the embodiment, it is possible to achieve a reduction in size and cost by arranging the first imaging optical element 5a so as to be close to the polygon mirror 4 such that Inequality (4) is satisfied.

In the light scanning apparatus 101 according to the embodiment, since d₁ and d₂ are 13.8 mm and 105.2 mm, respectively, as shown in Table 1, Inequality (4) is satisfied.

As described above, in the light scanning apparatus 101 according to the embodiment, the first imaging optical system is constituted by the single first imaging optical element 5a.

Therefore, when the shape of one of the incident surface and the exit surface of the first imaging optical element 5a is set, the shape of the other is determined in order to condense the first light flux on the first surface to be scanned 7a.

Therefore, as a comparative example of the first imaging optical element 5a, an imaging optical element 5p an incident surface and an exit surface of which have a concave shape and a convex shape, respectively, is considered.

It is generally known that such combination of the incident surface and the exit surface in the imaging optical element 5p can set the sub-scanning magnification to be low to suppress a deterioration in optical performance due to a manufacturing error.

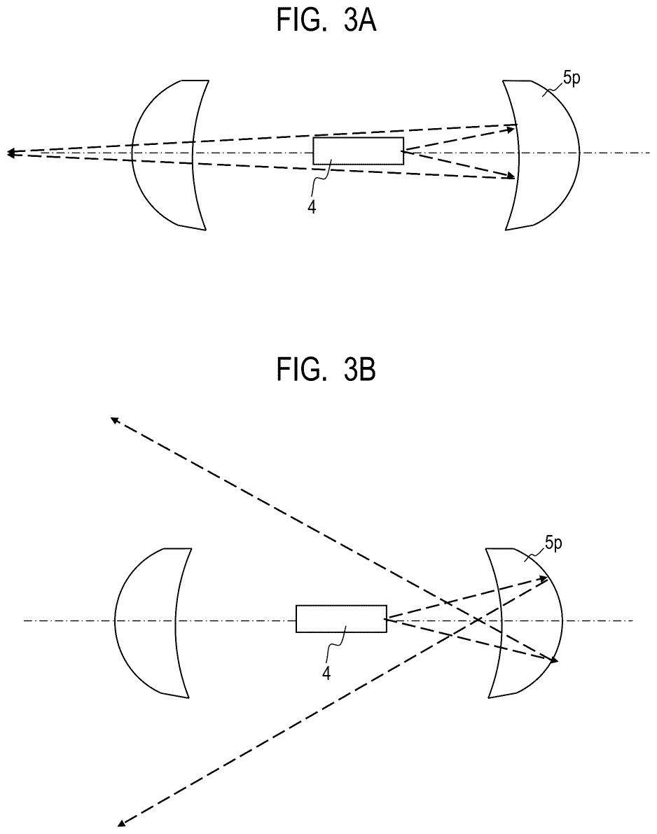

FIGS. 3A and 3B show schematic sub-scanning cross sectional views illustrating states in which opposite side ghosts generated by marginal rays of an on-axis light flux deflected by the polygon mirror 4 being incident on the incident surface and the exit surface of the imaging optical element 5p travel, respectively.

Specifically, the imaging optical element 5p shown in FIGS. 3A and 3B is an imaging optical element disclosed in Japanese Patent Laid-Open No. 2018-124325 in which the curvature radii of sagittal line Rᵢ and Rₒ (identical to r_{z}, respectively) on the optical axis of the incident surface and the exit surface thereof are −15.76 mm and −7.50 mm, respectively.

Here, when a shape factor F is defined as the following Expression (5), the shape factor F of the imaging optical element 5p is −2.82:

$$F = \frac{{R}_{o} + {R}_{i}}{{R}_{o} - {R}_{i}} . \qquad ( 5 )$$

First, as shown in FIG. 3A, the opposite side ghost generated on the incident surface forms a convergent light flux since the incident surface of the imaging optical element 5p has a concave shape.

On the other hand, as shown in FIG. 3B, the opposite side ghost generated on the exit surface is once condensed and then forms a diffused light flux since the exit surface of the imaging optical element 5p has a convex shape.

That is, in the imaging optical element 5p the incident surface and the exit surface of which have the concave shape and the convex shape, respectively, the opposite side ghost generated on the incident surface forms a strong convergent light flux, so that the light flux width thereof becomes relatively narrow.

Therefore, it is possible to make the opposite side ghost generated on the incident surface travel to outside of an effective region of an imaging optical element provided on the opposite side by forming the incident surface as s sagittal line tilt surface in the imaging optical element 5p.

Thereby, it is possible to suppress the opposite side ghost from reaching a surface to be scanned provided on the opposite side.

On the other hand, since the opposite side ghost generated on the exit surface of the imaging optical element 5p forms a diffused light flux, the diffused light flux passes through the effective region of the imaging optical element provided on the opposite side, even if the exit surface is formed as a sagittal tilt surface. Therefore, the opposite side ghost reaches the surface to be scanned provided on the opposite side.

This is because the imaging optical system is constituted by the single imaging optical element 5p, and the exit surface of the imaging optical element 5p is formed so as to have a relatively strong convex shape, namely such that a convex curvature radius is small.

Therefore, in the first imaging optical element 5a provided in the light scanning apparatus 101 according to the embodiment, the incident surface and the exit surface are formed so as to suppress any of the opposite side ghosts generated on the incident surface and the exit surface from reaching the surface to be scanned on the opposite side.

Specifically, a combination of the sagittal line shapes of the incident surface and the exit surface is appropriately selected such that light flux widths and spreads of the opposite side ghosts generated on the incident surface and the exit surface of the first imaging optical element 5a are appropriately set.

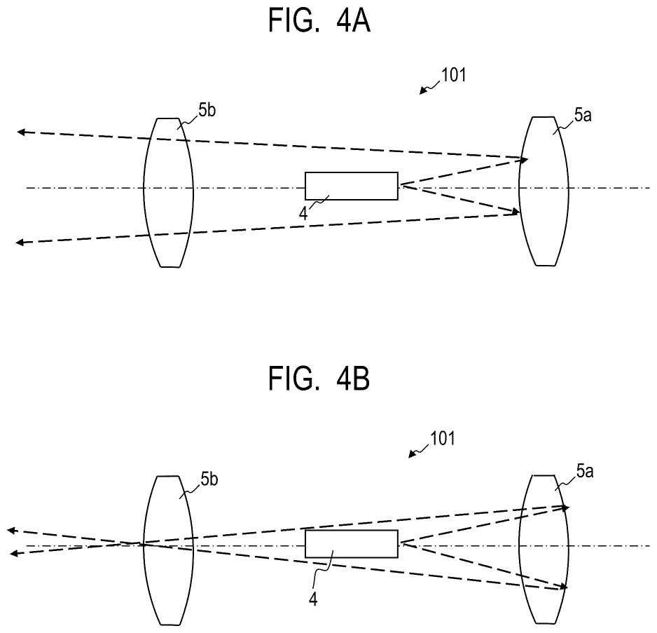

FIGS. 4A and 4B show schematic sub-scanning cross sectional views illustrating states in which opposite side ghosts generated by marginal rays of the on-axis light flux deflected by the polygon mirror 4 being incident on the incident surface and the exit surface of the first imaging optical element 5a travel, respectively.

As shown in FIGS. 4A and 4B, the convex shape of the exit surface is weakened compared to the imaging optical element 5p, while the incident surface is formed so as to have a convex shape for bending, in the first imaging optical element 5a provided in the light scanning apparatus 101 according to the embodiment.

Thereby, a total optical power determined from the shapes of the incident surface and the exit surface of the first imaging optical element 5a and that determined from the shapes of the incident surface and the exit surface of the imaging optical element 5p can be made substantially equal to each other.

As shown in FIG. 4A, the opposite side ghost generated on the incident surface forms a diffused light flux since the incident surface of the first imaging optical element 5a has the convex shape.

At first glance, it seems that it is difficult to make the opposite side ghost travel toward outside of an effective region of the second imaging optical element 5b provided on the opposite side, even if the incident surface is formed as a sagittal line tilt surface.

However, in fact, the convex shape of the incident surface is selected such that a light flux width of the opposite side ghost generated on the incident surface is smaller than a width of the effective region of the second imaging optical element 5b in the sub-scanning cross section.

Therefore, it is possible to suppress the opposite side ghost generated on the incident surface from reaching the second surface to be scanned 7b provided on the opposite side by forming the incident surface as the sagittal line tilt surface.

Further, as shown in FIG. 4B, the exit surface of the first imaging optical element 5a is bent so as to have a gentle convex shape as compared with the exit surface of the imaging optical element 5p.

Therefore, a distance between the exit surface of the first imaging optical element 5a and a condensation point at which the opposite side ghost generated on the exit surface of the first imaging optical element 5a is once condensed is larger than that between the exit surface of the imaging optical element 5p and a condensation point at which the opposite side ghost generated on the exit surface of the imaging optical element 5p is once condensed.

Thereby, a light flux width of the opposite side ghosts generated on the exit surface of the first imaging optical element 5a when incident on the second imaging optical element 5b arranged on the opposite side are reduced.

Therefore, it becomes easy to make the opposite side ghost generated on the exit surface of the first imaging optical element 5a travel toward the outside of the effective region of the second imaging optical element 5b by forming the exit surface of the first imaging optical element 5a as the sagittal line tilt surface.

As described above, in the light scanning apparatus 101 according to the embodiment, the combination of the sagittal line shapes of the incident surface and the exit surface of the first imaging optical element 5a is appropriately selected.

Thereby, any of the opposite side ghosts generated on the incident surface and the exit surface of the first imaging optical element 5a can be suppressed from reaching the second surface to be scanned 7b on the opposite side by causing them to travel outside the effective region of the second imaging optical element 5b on the opposite side.

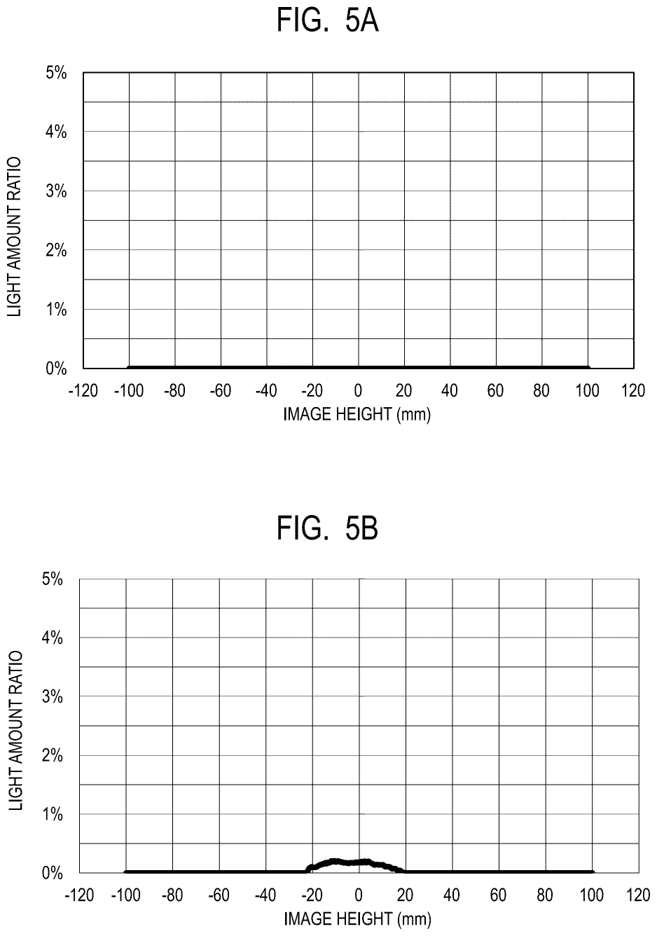

FIGS. 5A and 5B show values of ratios of light amounts of the opposite side ghosts generated on the incident surface and the exit surface of the first imaging optical element 5a to a light amount of the second light flux at respective image heights on the second surface to be scanned 7b on the opposite side, respectively.

In general, it is known that the value of the ratio of the opposite side ghost, in one embodiment, is 5% or less, and yet, in another embodiment, 3% or less, in consideration of being mounted on the image forming apparatus.

As described above, in the light scanning apparatus 101 according to the embodiment, the light flux widths of the opposite side ghosts generated on the incident surface and the exit surface of the first imaging optical element 5a are appropriately set by appropriately selecting the sagittal line shapes of them.

Thereby, as shown in FIGS. 5A and 5B, the values of the ratios of the opposite side ghosts generated on the incident surface and the exit surface of the first imaging optical element 5a at the respective image heights on the second surface to be scanned 7b are reduced to 0% and 0.2% or less, respectively.

That is, in the light scanning apparatus 101 according to the embodiment, it is possible to reduce the opposite side ghost that reaches the second surface to be scanned 7b on the opposite side by forming each of the incident surface and the exit surface of the first imaging optical element 5a as the sagittal line tilt changing surface.

In the light scanning apparatus 101 according to the embodiment, the curvature radii of sagittal line Rᵢ and Rₒ (identical to r_{z}, respectively) on the optical axis of the incident surface and the exit surface of the first imaging optical element 5a are set to 30.55 mm and −10.00 mm, respectively, as shown in Tables 2 and 3.

Thereby, it is possible to achieve both of a reduction of the opposite side ghost that reaches the second surface to be scanned 7b on the opposite side and a reduction in size due to a reduction in optical path length of the first imaging optical system.

Specifically, the first imaging optical element 5a can be arranged close to the polygon mirror 4 by setting the curvature radii of sagittal line Rᵢ and Rₒ on the optical axis of the incident surface and the exit surface of the first imaging optical element 5a as described above.

In addition, it is possible to cause the opposite side ghost generated on each of the incident surface and the exit surface of the first imaging optical element 5a to travel to outside of an effective region of the second imaging optical element 5b provided on the opposite side.

In the light scanning apparatus 101 according to one embodiment, the following Inequality (6) regarding the shape factor F can be satisfied to effectively achieve a reduction of an optical path length, downsizing, and a reduction of the opposite side ghost:

−2.7≤F<1.0 (6).

If the value falls below the lower limit value in Inequality (6), the opposite side ghost generated on the exit surface of the first imaging optical element 5a becomes a strong divergent light flux as shown in FIG. 3B, for example, so that it is difficult to reduce the opposite side ghost reaching the second surface to be scanned 7b on the opposite side.

On the other hand, if the value is equal to or exceeds the upper limit value in Inequality (6), the exit surface of the first imaging optical element 5a has a planar shape, so that the opposite side ghost generated on the exit surface of the first imaging optical element 5a becomes a simple divergent light flux which is not condensed once. Therefore, it is difficult to reduce the opposite side ghost reaching the second surface to be scanned 7b on the opposite side.

If the value is equal to or exceeds the upper limit value in Inequality (6), a principal plane is too close to the polygon mirror 4.

In this case, a magnification β in the sub-scanning cross section in an imaging relationship in which a deflection point of the first light flux on the first deflecting surface 4a of the polygon mirror 4 is set as an object point and a condensed point of the first light flux on the first surface to be scanned 7a is set as an image point becomes extremely large, so that it becomes very sensitive to manufacturing errors. Further, an imaging performance deteriorates since it is difficult to correct aberrations.

In the light scanning apparatus 101 according to one embodiment, the following Inequality (6a) be satisfied instead of Inequality (6):

−1.7≤F≤0.7 (6a).

When Inequality (6a) is satisfied, the light flux width of the opposite side ghost generated on each of the incident surface and the exit surface of the first imaging optical element 5a is reduced, so that it is possible to further reduce the opposite side ghost reaching the second surface to be scanned 7b on the opposite side.

In addition, the first imaging optical element 5a can be arranged close to the polygon mirror 4, so that the optical path length can be further reduced since the light flux width of the opposite side ghost is reduced.

In the light scanning apparatus 101 according to another embodiment, the following Inequality (6b) be satisfied instead of Inequality (6a):

−1.15≤F≤0.56 (6b).

When Inequality (6b) is satisfied, the optical path length can be further reduced, and the opposite side ghost reaching the second surface to be scanned 7b can be further reduced.

In the light scanning apparatus 101 according to the embodiment, Inequalities (6), (6a) and (6b) are satisfied since the shape factor F is set to −0.51.

Accordingly, the opposite side ghost reaching the second surface to be scanned 7b can be remarkably reduced as shown in FIGS. 5A and 5B.

Further, the first imaging optical element 5a can be arranged such that the optical path length between the polygon mirror 4 and the first imaging optical element 5a is about 1/10 of the optical path length between the polygon mirror 4 and the first surface to be scanned 7a.

Thereby, it is possible to achieve a reduction in size and cost of the light scanning apparatus 101 according to the embodiment.

In the light scanning apparatus 101 according to the embodiment, a position of the principal plane is set so as to satisfy the following Inequality (7) for the magnification β in the sub-scanning cross section in the imaging relationship in which the deflection point of the first light flux on the first deflecting surface 4a is the object point and the condensed point of the first light flux on the first surface to be scanned 7a is the image point:

−7.00≤β≤−5.35 (7).

In the light scanning apparatus 101 according to the embodiment, it is possible to suppress a deterioration in optical performances due to manufacturing errors, and to reduce an opposite side ghost reaching the second surface to be scanned 7b when Inequality (7) is satisfied.

If the value falls below the lower limit value in Inequality (7), the magnification β in the sub-scanning cross section increases, so that a variation when the manufacturing error occurs becomes very large, and thus, an image quality of a formed image may deteriorate.

On the other hand, when the value exceeds the upper limit value in Inequality (7), in one embodiment, the first imaging optical element 5a is arranged at a position largely separated from the polygon mirror 4, which leads to an increase in cost.

On the contrary, when the first imaging optical element 5a is arranged at a position close to the polygon mirror 4, the principal plane approaches the first surface to be scanned 7a, namely a shape of the first imaging optical element 5a approaches that of the imaging optical element 5p in the related art, so that it is difficult to reduce the opposite side ghost.

In the light scanning apparatus 101 according to the embodiment, Inequality (7) is satisfied since the magnification β in the sub-scanning cross section is set to −5.98.

Thereby, it is possible to achieve both of a suppression of the deterioration of the optical performance due to the manufacturing error and a reduction of the opposite side ghost reaching the second surface to be scanned 7b.

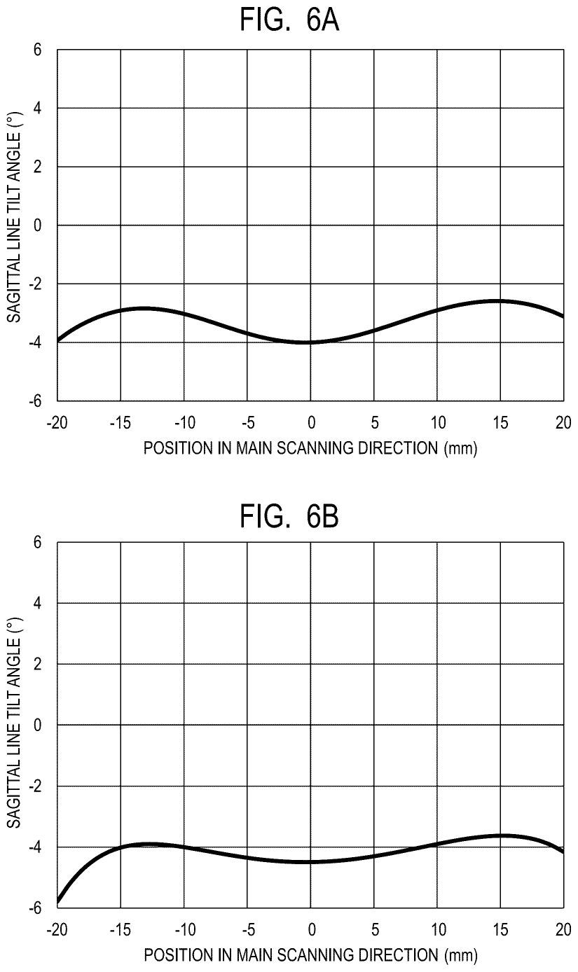

FIGS. 6A and 6B show positional dependences in the main scanning direction of sagittal line tilt angles (sagittal line tilt amounts) of the incident surface and the exit surface of the first imaging optical element 5a provided in the light scanning apparatus 101 according to the embodiment, respectively.

Here, the sagittal line tilt angle is an angle formed between a normal line and the main scanning cross section including the optical axis in the sub-scanning cross section.

As shown in FIGS. 6A and 6B, the sagittal line tilt angles of the incident surface and the exit surface of the first imaging optical element 5a are set to −4.0° and −4.5° on the optical axis of the first imaging optical system, respectively.

Further, in the light scanning apparatus 101 according to one embodiment, an absolute value of the sagittal line tilt angle is set so as to be the largest on the optical axis in at least one of the incident surface and the exit surface of the first imaging optical element 5a.

In particular, in one embodiment, the absolute value of the sagittal line tilt angle of the incident surface of the first imaging optical element 5a is set so as to be the largest on the optical axis.

Thereby, it is possible to minimize an optical path of the opposite side ghost generated at a position of the incident surface of the first imaging optical element 5a on the optical axis of the first imaging optical system among the opposite side ghosts generated at respective positions in the main scanning direction of the incident surface of the first imaging optical element 5a when the opposite side ghost travels on the opposite side.

Further, the opposite side ghost generated at the position of the incident surface of the first imaging optical element 5a on the optical axis of the first imaging optical system travels toward an on-axis deflection point on the first deflecting surface 4a of the polygon mirror 4 when projected onto the main scanning cross section.

Therefore, the sagittal line tilt angle of the incident surface of the first imaging optical element 5a is set such that the opposite side ghost generated at the position of the incident surface of the first imaging optical element 5a on the optical axis travels below a rotor portion (not shown) of the polygon mirror 4 in the light scanning apparatus 101 according to the embodiment.

In the light scanning apparatus 101 according to the embodiment, each of the incident surface and the exit surface of the first imaging optical element 5a is formed as a sagittal line tilt changing surface as shown in FIGS. 6A and 6B.

Thereby, the opposite side ghost reaching the second surface to be scanned 7b can be sufficiently reduced as shown in FIGS. 5A and 5B.

In addition, in the light scanning apparatus 101 according to the embodiment, it is also possible to suppress a deterioration in optical performance by forming each of the incident surface and the exit surface of the first imaging optical element 5a as the sagittal line tilt changing surface.

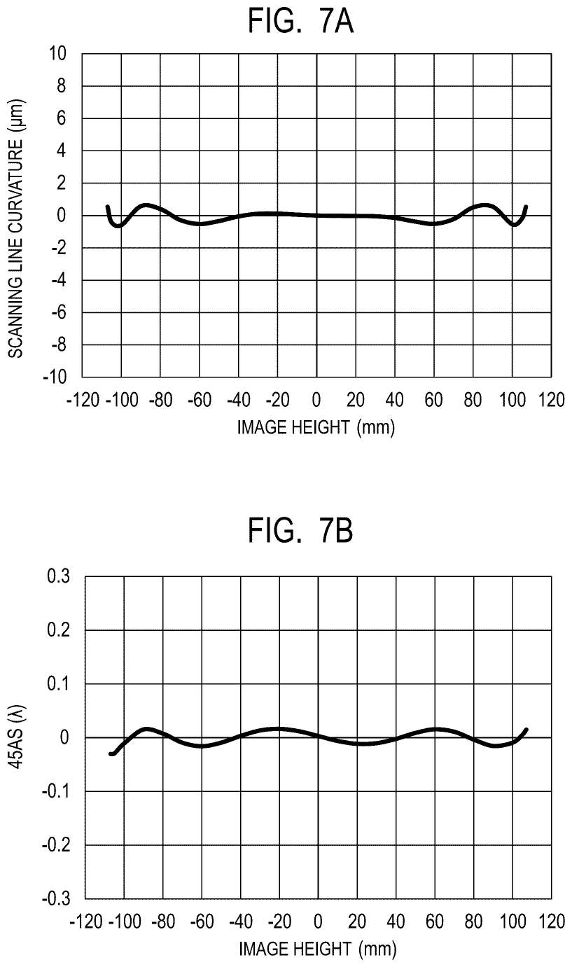

FIG. 7A shows a difference between an arrival position in the sub-scanning direction of the first light flux at each of image heights and that at the on-axis image height, namely a scanning line curvature on the first surface to be scanned 7a by the light scanning apparatus 101 according to the embodiment.

As shown in FIG. 7A, the scanning line curvature is sufficiently suppressed since the difference at each of the image heights on the first surface to be scanned 7a is within a range of ±1 μm in the light scanning apparatus 101 according to the embodiment.

Further, it is known that an aberration in which wavefronts are not aligned in a ±45° direction on an exit pupil surface, namely an astigmatism in the +45° direction (45AS) occurs when a predetermined optical surface is formed as a sagittal line tilt surface.

In the light scanning apparatus 101 according to the embodiment, such wavefront aberration is also reduced well as described below.

FIG. 7B shows a magnitude of the 45AS at each of the image heights on the first surface to be scanned 7a by the light scanning apparatus 101 according to the embodiment.

As shown in FIG. 7B, the wavefront aberration is reduced since the 45AS at each of the image heights on the first surface to be scanned 7a is within a range of ±0.02λ in the light scanning apparatus 101 according to the embodiment.

Thereby, it is possible to form a favorable imaging spot on the first surface to be scanned 7a.

As described above, in the light scanning apparatus 101 according to the embodiment, the incident surface and the exit surface of the first imaging optical element 5a are formed as the sagittal line tilt changing surfaces so as to suppress the opposite side ghost generated in the first imaging optical element 5a from reaching the second surface to be scanned 7b.

In addition, the sagittal line tilt angle of each of the incident surface and the exit surface of the first imaging optical element 5a is appropriately set so as to suppress the deterioration of optical performance.

Thereby, it is possible to reduce the opposite side ghost reaching the second surface to be scanned 7b without providing a coating or a fine structure on the first imaging optical element 5a in the light scanning apparatus 101 according to the embodiment, which employs in-deflection-plane scanning and non-uniform scanning properties in order to achieve a reduction in thickness and size.

In one embodiment, the ghost light reaching the second surface to be scanned 7b can be remarkably reduced only by a shape of the optical surface of the first imaging optical element 5a to achieve a reduction in cost and a reduction in size including a reduction in thickness in the light scanning apparatus 101 according to the embodiment.

In other words, it is possible to provide the light scanning apparatus 101 according to the embodiment of in-deflection-plane scanning type and non-uniform scanning type with achieving both of cost reduction and size reduction by effectively suppressing the generation of the ghost light reaching the second surface to be scanned 7b by the shape of the optical surface of the first imaging optical element 5a.

Although the shape of the first imaging optical element 5a has been described above, the above discussion can be similarly applied to the second imaging optical element 5b.

In the light scanning apparatus 101 according to the embodiment, a value of a ratio of scanning speeds at outermost off-axis image heights to the scanning speed at an on-axis image height on the first surface to be scanned 7a is about 1.3 as described above with reference to FIG. 2.

However, the disclosure is not limited thereto, and for example, if a meridional line shape of the first imaging optical element 5a is set such that the value of the ratio is between 1.05 and 2.00, the above-described effect can be given.

In other words, in the light scanning apparatus 101 according to the embodiment, the value of the ratio of the scanning speeds at the outermost off-axis image heights (outermost off-axis scanning speed) to the scanning speed at the on-axis image height (on-axis scanning speed) on the first surface to be scanned 7a is represented by P, in one embodiment, the following Inequality (8) be satisfied:

1.05≤P≤2.00 (8).

Further, a fine structure having a size equal to or smaller than a wavelength of the first light flux transferred by the mold may be formed on the optical surface of the first imaging optical element 5a in addition to forming the optical surface of the first imaging optical element 5a as described above, in the light scanning apparatus 101 according to the embodiment.

Furthermore, instead of forming the fine structure on the optical surface, a film on which a fine structure pattern is formed may be applied or attached on the optical surface, or a coating having an antireflection function, namely an antireflection film may be provided on the optical surface.

In this case, it is possible to further reduce ghost light that is generated on the optical surface of the first imaging optical element 5a and reaches the second surface to be scanned 7b when the first imaging optical element 5a is arranged very close to the polygon mirror 4 in the light scanning apparatus 101 according to the embodiment.

That is, it is possible to achieve further effective suppression of the generation of the opposite side ghost and downsizing in the light scanning apparatus 101 according to the embodiment.

### Second Embodiment

Next, a light scanning apparatus according to a second embodiment of the disclosure is described. The light scanning apparatus according to the embodiment has the same configuration as that of the light scanning apparatus according to the first embodiment except that shapes of the first and second imaging optical elements 5a and 5b are different. Therefore, the same members are denoted by the same numerals, and the description thereof is omitted.

That is, specification values of the light scanning apparatus according to the embodiment are the same as those of the light scanning apparatus 101 according to the first embodiment shown in Table 1.

Numerical values of shapes of the incident surface and the exit surface of the first imaging optical element 5a provided in the light scanning apparatus according to the embodiment are shown in the following Tables 4 and 5.

Shapes of the incident surface and the exit surface of the second imaging optical element 5b are the same as those of the incident surface and the exit surface of the first imaging optical element 5a, respectively, so that the description thereof is omitted.

TABLE 4

| Main scanning cross section | | | Sub-scanning cross section | | | |
|---|---|---|---|---|---|---|
| (Meridional line shape) | | | (Sagittal line shape) | | | |
| | Scanning | Scanning | Sagittal | | Sagittal | |
| | start side | end side | line R | | line tilt | |
| RY | 9.827.E+01 | 9.827.E+01 | rZ | −1.632.E+02 | M0_1 | −9.000.E−02 |
| KY | −1.124.E+01 | | E1 | 8.273.E−04 | M1_1 | 3.329.E−04 |
| B1 | 0.000.E+00 | 0.000.E+00 | E2 | 3.906.E−05 | M2_1 | 4.946.E−04 |
| B2 | 0.000.E+00 | 0.000.E+00 | E3 | −1.146.E−05 | M3_1 | −3.450.E−06 |
| B3 | 2.772.E−06 | 2.772.E−06 | E4 | −2.235.E−07 | M4_1 | −2.141.E−06 |
| B4 | −2.308.E−05 | −2.375.E−05 | E5 | 9.999.E−09 | M5_1 | 2.436.E−08 |
| B5 | 0.000.E+00 | 0.000.E+00 | E6 | 7.642.E−10 | M6_1 | 5.618.E−09 |
| B6 | 4.554.E−08 | 4.594.E−08 | E7 | 0.000.E+00 | M7_1 | −4.492.E−11 |
| B7 | 0.000.E+00 | 0.000.E+00 | E8 | 0.000.E+00 | M8_1 | −8.436.E−12 |
| B8 | −4.554.E−11 | −4.201.E−11 | E9 | 0.000.E+00 | M9_1 | 2.837.E−14 |
| B9 | 0.000.E+00 | 0.000.E+00 | E10 | 0.000.E+00 | M10_1 | 5.672.E−15 |
| B10 | 1.497.E−14 | 1.431.E−14 | E11 | 0.000.E+00 | M11_1 | 0.000.E+00 |
| B11 | 0.000.E+00 | 0.000.E+00 | E12 | 0.000.E+00 | M12_1 | 0.000.E+00 |
| B12 | 0.000.E+00 | 0.000.E+00 | E13 | 0.000.E+00 | M13_1 | 0.000.E+00 |
| B13 | 0.000.E+00 | 0.000.E+00 | E14 | 0.000.E+00 | M14_1 | 0.000.E+00 |
| B14 | 0.000.E+00 | 0.000.E+00 | E15 | 0.000.E+00 | M15_1 | 0.000.E+00 |
| B15 | 0.000.E+00 | 0.000.E+00 | E16 | 0.000.E+00 | M16_1 | 0.000.E+00 |
| B16 | 0.000.E+00 | 0.000.E+00 | | | | |

TABLE 5

| Main scanning cross section | | | Sub-scanning cross section | | | |
|---|---|---|---|---|---|---|
| (Meridional line shape) | | | (Sagittal line shape) | | | |
| | Scanning | Scanning | Sagittal | | Sagittal | |
| | start side | end side | line R | | line tilt | |
| RY | −1.766.E+02 | −1.766.E+02 | rZ | −8.000.E+00 | M0_1 | −9.915.E−02 |
| KY | 4.169.E+01 | | E1 | 2.076.E−04 | M1_1 | 1.718.E−04 |
| B1 | 0.000.E+00 | 0.000.E+00 | E2 | 2.118.E−04 | M2_1 | 2.184.E−04 |
| B2 | 0.000.E+00 | 0.000.E+00 | E3 | −2.717.E−06 | M3_1 | −3.117.E−07 |
| B3 | 1.250.E−05 | 1.250.E−05 | E4 | −6.976.E−07 | M4_1 | −4.711.E−07 |
| B4 | −1.048.E−05 | −9.749.E−06 | E5 | −6.581.E−09 | M5_1 | 1.796.E−09 |
| B5 | 0.000.E+00 | 0.000.E+00 | E6 | 1.113.E−09 | M6_1 | 3.313.E−10 |
| B6 | 7.356.E−10 | 5.126.E−10 | E7 | 0.000.E+00 | M7_1 | 1.163.E−11 |
| B7 | 0.000.E+00 | 0.000.E+00 | E8 | 0.000.E+00 | M8_1 | 0.000.E+00 |
| B8 | 2.078.E−11 | 1.736.E−11 | E9 | 0.000.E+00 | M9_1 | −1.457.E−14 |
| B9 | 0.000.E+00 | 0.000.E+00 | E10 | 0.000.E+00 | M10_1 | 6.454.E−18 |
| B10 | −1.895.E−14 | −1.027.E−14 | E11 | 0.000.E+00 | M11_1 | 0.000.E+00 |
| B11 | 0.000.E+00 | 0.000.E+00 | E12 | 0.000.E+00 | M12_1 | 0.000.E+00 |
| B12 | 0.000.E+00 | 0.000.E+00 | E13 | 0.000.E+00 | M13_1 | 0.000.E+00 |
| B13 | 0.000.E+00 | 0.000.E+00 | E14 | 0.000.E+00 | M14_1 | 0.000.E+00 |
| B14 | 0.000.E+00 | 0.000.E+00 | E15 | 0.000.E+00 | M15_1 | 0.000.E+00 |
| B15 | 0.000.E+00 | 0.000.E+00 | E16 | 0.000.E+00 | M16_1 | 0.000.E+00 |
| B16 | 0.000.E+00 | 0.000.E+00 | | | | |

A meridional line shape of each of the incident surface and the exit surface of the first imaging optical element 5a provided in the light scanning apparatus according to the embodiment has an aspherical shape as expressed by the above-described Expression (1).

As shown in Tables 4 and 5, some values of the aspherical coefficients Bi are different between a scanning start side and a scanning end side.

Further, a sagittal line shape of each of the incident surface and the exit surface of the first imaging optical element 5a provided in the light scanning apparatus according to the embodiment has an aspherical shape as expressed by the above-described Expression (2).

Furthermore, a curvature radius (curvature radius of sagittal line) r in the sub-scanning cross section of the incident surface and the exit surface of the first imaging optical element 5a provided in the light scanning apparatus according to the embodiment changes in accordance with a position Y in the main scanning direction as expressed by the above-described Expression (3).

As shown in Tables 4 and 5, each of the incident surface and the exit surface of the first imaging optical element 5a provided in the light scanning apparatus according to the embodiment is formed as a surface whose tilt angle changes in accordance with the position Y in the main scanning direction, namely as a sagittal line tilt changing surface.

Thereby, the opposite side ghost can be suppressed from reaching the second surface to be scanned 7b.

In the light scanning apparatus according to the embodiment, Inequality (4) is satisfied since d₁ and d₂ are 13.8 mm and 105.2 mm, respectively, as shown in Table 1.

In the light scanning apparatus according to the embodiment, curvature radii of sagittal line Rᵢ and Rₒ (identical to r_{z}, respectively) on the optical axis of the incident surface and the exit surface of the first imaging optical element 5a are set to −163.20 mm and −8.00 mm, respectively, as shown in Tables 4 and 5.

Therefore, Inequalities (6), (6a) and (6b) are satisfied since a shape factor F is calculated as −1.10 from Expression (5).

Thereby, an optical path length can be reduced, and the opposite side ghost reaching the second surface to be scanned 7b can be reduced.

In the light scanning apparatus according to the embodiment, Inequality (7) is satisfied since a magnification β in the sub-scanning cross section is set to −5.60.

Thereby, it is possible to achieve both of a suppression of a deterioration of optical performance due to the manufacturing error and a reduction of the opposite side ghost reaching the second surface to be scanned 7b.

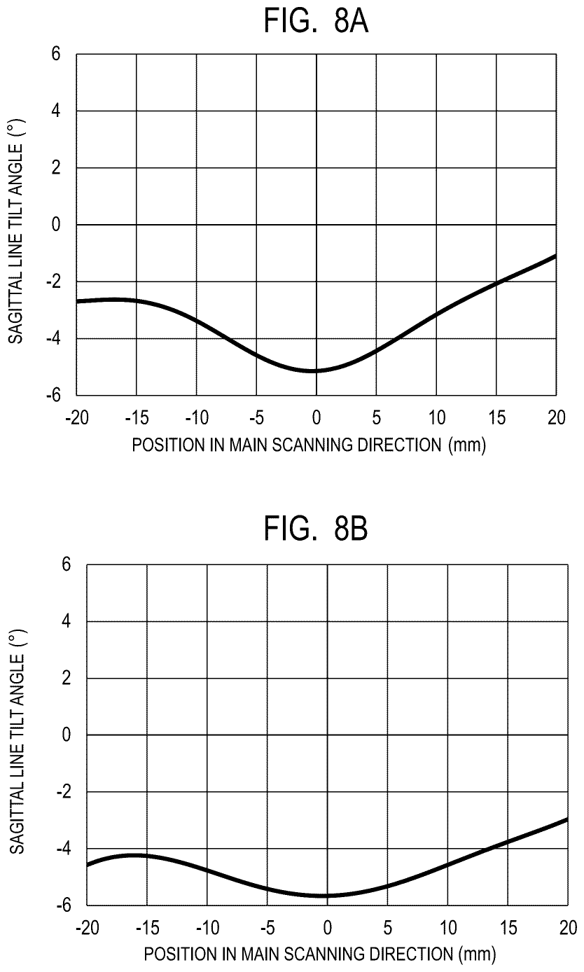

FIGS. 8A and 8B show positional dependences in the main scanning direction of sagittal line tilt angles of the incident surface and the exit surface of the first imaging optical element 5a provided in the light scanning apparatus according to the embodiment, respectively.

As shown in FIGS. 8A and 8B, the sagittal line tilt angles of the incident surface and the exit surface of the first imaging optical element 5a are set to −5.1° and −5.7° on the optical axis of the first imaging optical system, respectively.

Further, as shown in FIG. 8A, absolute values of the sagittal line tilt angles at respective positions in the main scanning direction of the incident surface of the first imaging optical element 5a are set so as to be the largest on the optical axis of the first imaging optical system in the light scanning apparatus according to the embodiment.

Thereby, the opposite side ghost generated at the position of the incident surface of the first imaging optical element 5a on the optical axis of the first imaging optical system can be caused to travel below a rotor portion (not shown) of the polygon mirror 4.

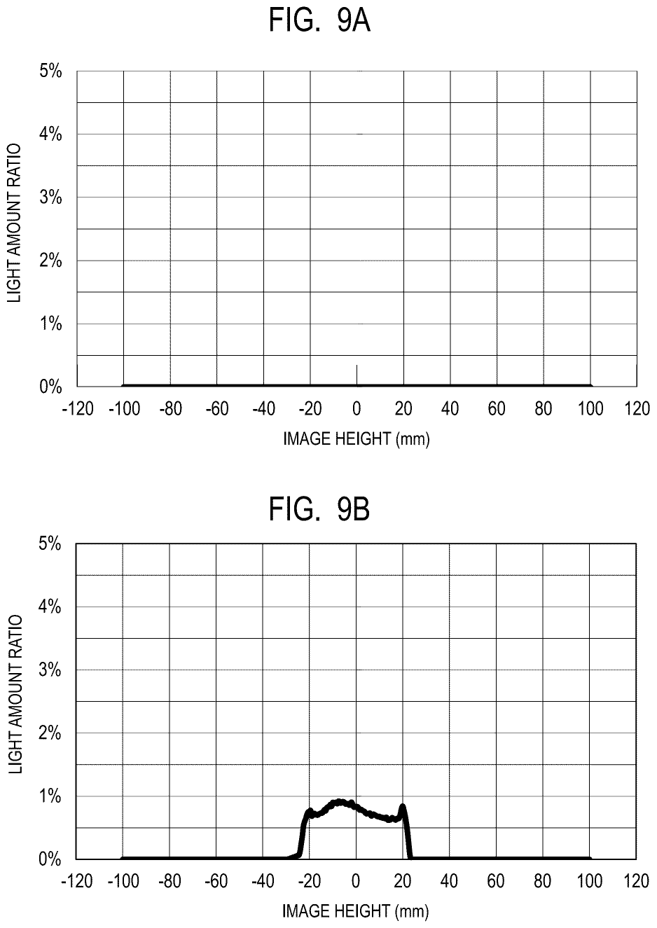

FIGS. 9A and 9B show values of ratios of light amounts of the opposite side ghosts generated on the incident surface and the exit surface of the first imaging optical element 5a to a light amount of the second light flux at respective image heights on the second surface to be scanned 7b on the opposite side in the light scanning apparatus according to the embodiment, respectively.

As described above, in the light scanning apparatus according to the embodiment, the light flux widths of the opposite side ghosts generated on the incident surface and the exit surface of the first imaging optical element 5a are appropriately set by appropriately selecting sagittal line shapes of them.

Thereby, the above-described values of the ratios of the opposite side ghosts generated on the incident surface and the exit surface of the first imaging optical element 5a at the respective image heights on the second surface to be scanned 7b can be reduced to 0% and 1.0% or less, respectively, as shown in FIGS. 9A and 9B.

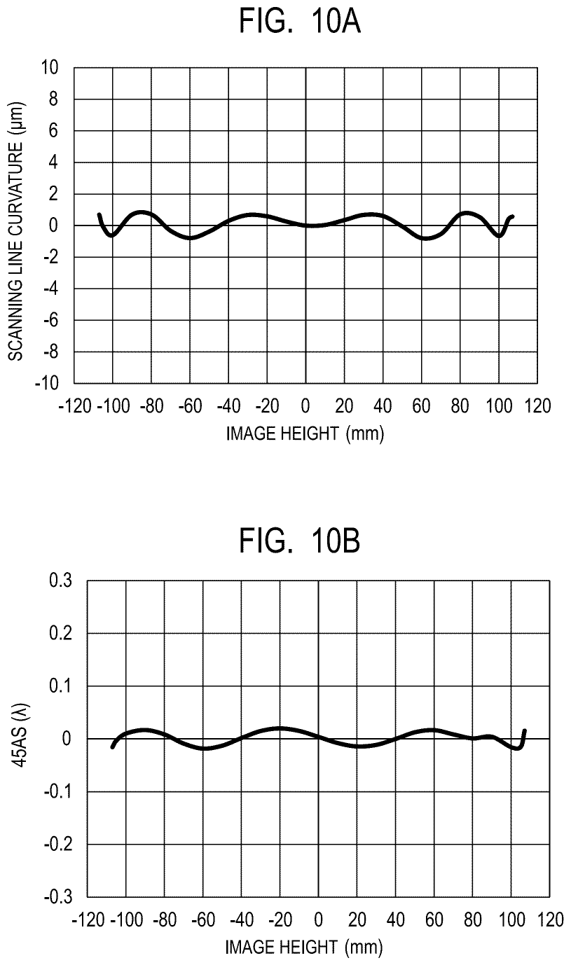

FIG. 10A shows a difference between an arrival position in the sub-scanning direction of the first light flux at each of the image heights and that at the on-axis image height, namely a scanning line curvature on the first surface to be scanned 7a by the light scanning apparatus according to the embodiment.

As shown in FIG. 10A, the difference at each of the image heights on the first surface to be scanned 7a is within a range of ±1 μm, so that the scanning line curvature is sufficiently suppressed in the light scanning apparatus according to the embodiment.

FIG. 10B shows magnitudes of 45AS at the respective image heights on the first surface to be scanned 7a by the light scanning apparatus according to the embodiment.

As shown in FIG. 10B, 45AS at each of the image heights on the first surface to be scanned 7a is within a range of ±0.03λ, so that a wave aberration can be reduced in the light scanning apparatus according to the embodiment.

Thereby, it is possible to form a favorable imaging spot on the first surface to be scanned 7a.

As described above, in the light scanning apparatus according to the embodiment, the incident surface and the exit surface of the first imaging optical element 5a are formed as sagittal line tilt changing surfaces so as to suppress the opposite side ghost generated in the first imaging optical element 5a from reaching the second surface to be scanned 7b.

In addition, a sagittal line tilt angle of each of the incident surface and the exit surface of the first imaging optical element 5a is appropriately set so as to suppress a deterioration of optical performance.

Thereby, the opposite side ghost can be reduced with achieving a reduction in cost in the light scanning apparatus according to the embodiment which employs an in-deflection-plane scanning and a non-uniform scanning properties in order to achieve a reduction in thickness and a reduction in size.

Although the shape of the first imaging optical element 5a has been described above, the above discussion can be similarly applied to the second imaging optical element 5b.

### Third Embodiment

Next, a light scanning apparatus according to a third embodiment of the disclosure is described. The light scanning apparatus according to the embodiment has the same configuration as that of the light scanning apparatus according to the first embodiment except that shapes of the first and second imaging optical elements 5a and 5b are different. Therefore, the same members are denoted by the same numerals, and the description thereof is omitted.

That is, specification values of the light scanning apparatus according to the embodiment are the same as those of the light scanning apparatus 101 according to the first embodiment shown in Table 1.

Numerical values for shapes of the incident surface and the exit surface of the first imaging optical element 5a provided in the light scanning apparatus according to the embodiment are shown in the following Tables 6 and 7.

Shapes of the incident surface and the exit surface of the second imaging optical element 5b are the same as the shapes of the incident surface and the exit surface of the first imaging optical element 5a, respectively, so that the description thereof is omitted.

TABLE 6

| Main scanning cross section | | | Sub-scanning cross section | | | |
|---|---|---|---|---|---|---|
| (Meridional line shape) | | | (Sagittal line shape) | | | |
| | Scanning | Scanning | Sagittal | | Sagittal | |
| | start side | end side | line R | | line tilt | |
| RY | 9.827.E+01 | 9.827.E+01 | rZ | 1.099.E+01 | M0_1 | −1.200.E−01 |
| KY | −1.124.E+01 | | E1 | 3.734.E−05 | M1_1 | 3.918.E−04 |
| B1 | 0.000.E+00 | 0.000.E+00 | E2 | −2.579.E−04 | M2_1 | 7.288.E−04 |
| B2 | 0.000.E+00 | 0.000.E+00 | E3 | −9.350.E−06 | M3_1 | 3.135.E−08 |
| B3 | 2.772.E−06 | 2.772.E−06 | E4 | 4.376.E−08 | M4_1 | −2.374.E−06 |
| B4 | −2.308.E−05 | −2.375.E−05 | E5 | 2.354.E−08 | M5_1 | 4.922.E−09 |
| B5 | 0.000.E+00 | 0.000.E+00 | E6 | 2.348.E−09 | M6_1 | 5.562.E−09 |
| B6 | 4.554.E−08 | 4.594.E−08 | E7 | −1.062.E−11 | M7_1 | −2.780.E−12 |
| B7 | 0.000.E+00 | 0.000.E+00 | E8 | −2.704.E−12 | M8_1 | −3.333.E−12 |
| B8 | −4.554.E−11 | −4.201.E−11 | E9 | 0.000.E+00 | M9_1 | 0.000.E+00 |
| B9 | 0.000.E+00 | 0.000.E+00 | E10 | 0.000.E+00 | M10_1 | 0.000.E+00 |
| B10 | 1.497.E−14 | 1.431.E−14 | E11 | 0.000.E+00 | M11_1 | 0.000.E+00 |
| B11 | 0.000.E+00 | 0.000.E+00 | E12 | 0.000.E+00 | M12_1 | 0.000.E+00 |
| B12 | 0.000.E+00 | 0.000.E+00 | E13 | 0.000.E+00 | M13_1 | 0.000.E+00 |
| B13 | 0.000.E+00 | 0.000.E+00 | E14 | 0.000.E+00 | M14_1 | 0.000.E+00 |
| B14 | 0.000.E+00 | 0.000.E+00 | E15 | 0.000.E+00 | M15_1 | 0.000.E+00 |
| B15 | 0.000.E+00 | 0.000.E+00 | E16 | 0.000.E+00 | M16_1 | 0.000.E+00 |
| B16 | 0.000.E+00 | 0.000.E+00 | | | | |

TABLE 7

| Main scanning cross section | | | Sub-scanning cross section | | | |
|---|---|---|---|---|---|---|
| (Meridional line shape) | | | (Sagittal line shape) | | | |
| | Scanning | Scanning | Sagittal | | Sagittal | |
| | start side | end side | line R | | line tilt | |
| RY | −1.766.E+02 | −1.766.E+02 | rZ | −1.813.E+01 | M0_1 | −1.779.E−01 |
| KY | 4.169.E+01 | | E1 | −2.424.E−04 | M1_1 | 3.557.E−04 |
| B1 | 0.000.E+00 | 0.000.E+00 | E2 | 1.740.E−04 | M2_1 | 4.380.E−04 |
| B2 | 0.000.E+00 | 0.000.E+00 | E3 | −4.094.E−06 | M3_1 | 1.383.E−06 |
| B3 | 1.250.E−05 | 1.250.E−05 | E4 | −1.006.E−06 | M4_1 | −4.709.E−07 |
| B4 | −1.048.E−05 | −9.749.E−06 | E5 | −3.151.E−10 | M5_1 | −3.281.E−09 |
| B5 | 0.000.E+00 | 0.000.E+00 | E6 | 2.248.E−09 | M6_1 | −5.290.E−10 |
| B6 | 7.356.E−10 | 5.126.E−10 | E7 | 1.084.E−11 | M7_1 | 7.900.E−12 |
| B7 | 0.000.E+00 | 0.000.E+00 | E8 | −6.711.E−13 | M8_1 | 3.256.E−12 |
| B8 | 2.078.E−11 | 1.736.E−11 | E9 | 0.000.E+00 | M9_1 | 0.000.E+00 |
| B9 | 0.000.E+00 | 0.000.E+00 | E10 | 0.000.E+00 | M10_1 | 0.000.E+00 |
| B10 | −1.895.E−14 | −1.027.E−14 | E11 | 0.000.E+00 | M11_1 | 0.000.E+00 |
| B11 | 0.000.E+00 | 0.000.E+00 | E12 | 0.000.E+00 | M12_1 | 0.000.E+00 |
| B12 | 0.000.E+00 | 0.000.E+00 | E13 | 0.000.E+00 | M13_1 | 0.000.E+00 |
| B13 | 0.000.E+00 | 0.000.E+00 | E14 | 0.000.E+00 | M14_1 | 0.000.E+00 |
| B14 | 0.000.E+00 | 0.000.E+00 | E15 | 0.000.E+00 | M15_1 | 0.000.E+00 |
| B15 | 0.000.E+00 | 0.000.E+00 | E16 | 0.000.E+00 | M16_1 | 0.000.E+00 |
| B16 | 0.000.E+00 | 0.000.E+00 | | | | |

A meridional line shape of each of the incident surface and the exit surface of the first imaging optical element 5a provided in the light scanning apparatus according to the embodiment has an aspherical shape as expressed by the above-described Expression (1).

As shown in Tables 6 and 7, some values of the aspherical coefficients Bi are different between a scanning start side and a scanning end side.

Further, a sagittal line shape of each of the incident surface and the exit surface of the first imaging optical element 5a provided in the light scanning apparatus according to the embodiment has an aspherical shape as expressed by the above-described Expression (2).

Furthermore, a curvature radius (curvature radius of sagittal line) r in the sub-scanning cross section of the incident surface and the exit surface of the first imaging optical element 5a provided in the light scanning apparatus according to the embodiment changes in accordance with a position Y in the main scanning direction as expressed by the above-described Expression (3).

As shown in Tables 6 and 7, each of the incident surface and the exit surface of the first imaging optical element 5a provided in the light scanning apparatus according to the embodiment is formed as a surface whose tilt angle changes in accordance with the position Y in the main scanning direction, namely as a sagittal line tilt changing surface.

Thereby, the opposite side ghost can be suppressed from reaching the second surface to be scanned 7b.

In the light scanning apparatus according to the embodiment, Inequality (4) is satisfied since d₁ and d₂ are 13.8 mm and 105.2 mm, respectively, as shown in Table 1.

In the light scanning apparatus according to the embodiment, curvature radii of sagittal line Rᵢ and Rₒ (identical to r_{z}, respectively) on the optical axis of the incident surface and the exit surface of the first imaging optical element 5a are set to 10.99 mm and −18.13 mm, respectively, as shown in Tables 6 and 7.

Therefore, Inequalities (6), (6a) and (6b) are satisfied since a shape factor F is calculated as 0.25 from Expression (5).

Thereby, an optical path length can be reduced, and the opposite side ghost reaching the second surface to be scanned 7b can be reduced.

In the light scanning apparatus according to the embodiment, Inequality (7) is satisfied since the magnification β in the sub-scanning cross section is set to −6.63.

Thereby, it is possible to achieve both of a suppression of a deterioration of optical performance due to manufacturing errors and a reduction of the opposite side ghost reaching the second surface to be scanned 7b.

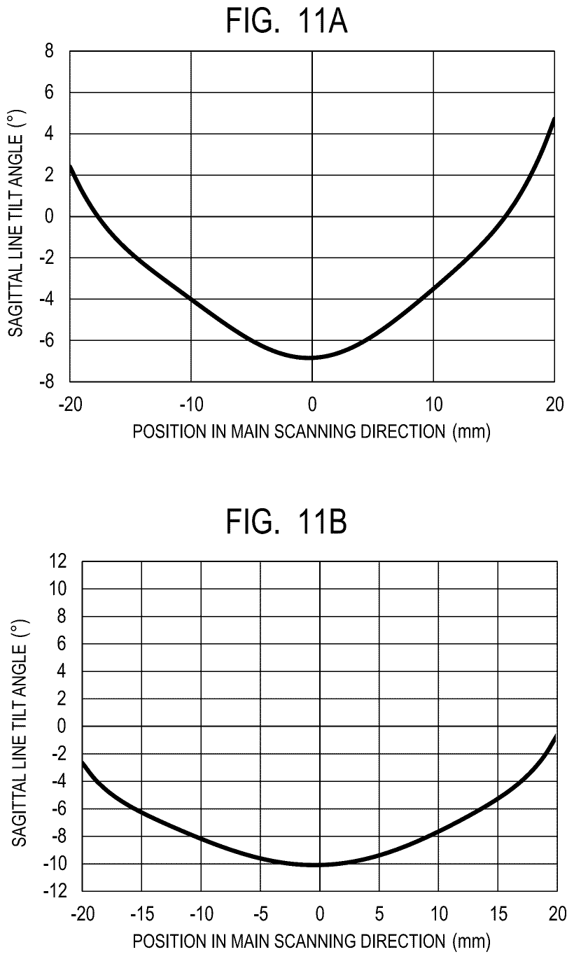

FIGS. 11A and 11B show positional dependences in the main scanning direction of sagittal line tilt angles of the incident surface and the exit surface of the first imaging optical element 5a provided in the light scanning apparatus according to the embodiment, respectively.

As shown in FIGS. 11A and 11B, the sagittal line tilt angles of the incident surface and the exit surface of the first imaging optical element 5a are set to −6.8° and −10.1°, respectively, on the optical axis of the first imaging optical system.

Further, as shown in FIG. 11A, absolute values of the sagittal line tilt angles at respective positions in the main scanning direction of the incident surface of the first imaging optical element 5a are set to be the largest on the optical axis of the first imaging optical system in the light scanning apparatus according to the embodiment.

Thereby, the opposite side ghost generated at a position of the incident surface of the first imaging optical element 5a on the optical axis of the first imaging optical system can be caused to travel below a rotor portion (not shown) of the polygon mirror 4.

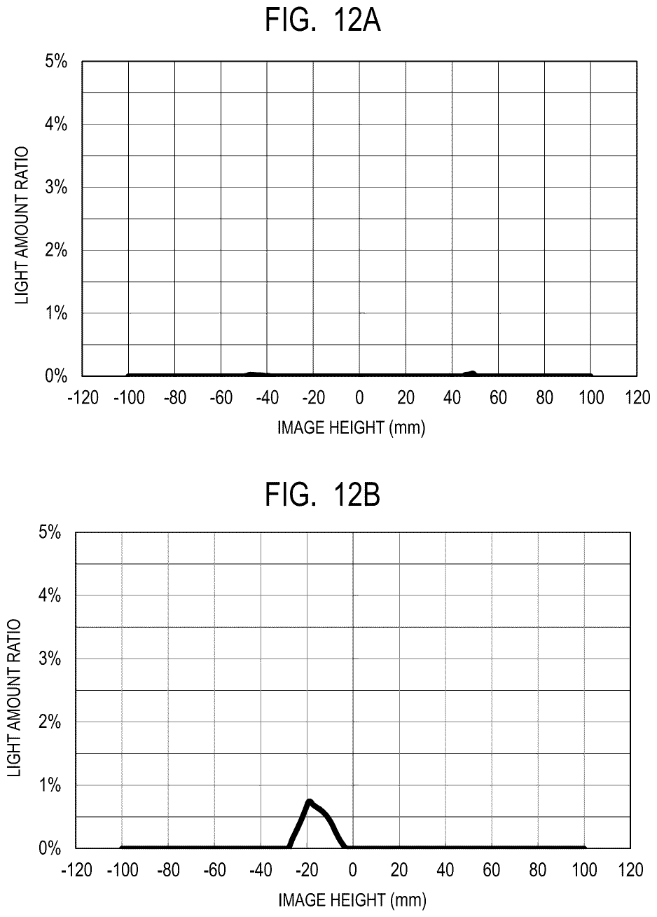

FIGS. 12A and 12B show values of ratios of light amounts of the opposite side ghosts generated on the incident surface and the exit surface of the first imaging optical element 5a to the light amount of the second light flux at each of the image heights on the second surface to be scanned 7b on the opposite side in the light scanning apparatus according to the embodiment, respectively.

As described above, in the light scanning apparatus according to the embodiment, light flux widths of the opposite side ghosts generated on the incident surface and the exit surface of the first imaging optical element 5a are appropriately set by appropriately selecting sagittal line shapes of them.

Thereby, as shown in FIGS. 12A and 12B, it is understood that the values of the ratios of the opposite side ghosts generated on the incident surface and the exit surface of the first imaging optical element 5a at each of the image heights on the second surface to be scanned 7b can be reduced to 0.8% or less.

In addition, as shown in FIGS. 12A and 12B, the light amounts of the opposite-side ghosts that are generated on the incident surface and the exit surface of the first imaging optical element 5a and reach the second surface to be scanned 7b increase at different image heights.

Therefore, a deterioration of an image quality of an image formed on the second surface to be scanned 7b is sufficiently suppressed.

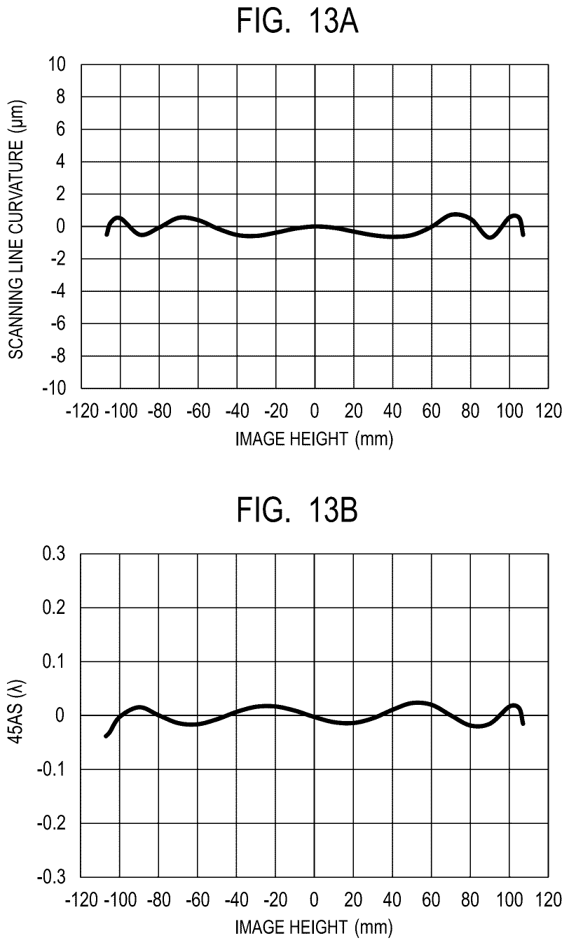

FIG. 13A shows a difference between an arrival position in the sub-scanning direction of the first light flux at each of the image heights and that at the on-axis image height, namely a scanning line curvature on the first surface to be scanned 7a by the light scanning apparatus according to the embodiment.

As shown in FIG. 13A, the difference at each of the image heights on the first surface to be scanned 7a is within a range of +1 μm, so that the scanning line curvature is sufficiently suppressed in the light scanning apparatus according to the embodiment.

FIG. 13B shows a magnitude of 45AS at each of image heights on the first surface to be scanned 7a by the light scanning apparatus according to the embodiment.

As shown in FIG. 13B, 45AS at each of the image heights on the first surface to be scanned 7a is within a range of +0.042, so that a wave aberration can be reduced in the light scanning apparatus according to the embodiment.

Thereby, it is possible to form a favorable imaging spot on the first surface to be scanned 7a.

As described above, in the light scanning apparatus according to the embodiment, the incident surface and the exit surface of the first imaging optical element 5a are formed as sagittal line tilt changing surfaces so as to suppress the opposite side ghost generated in the first imaging optical element 5a from reaching the second surface to be scanned 7b.

In addition, a sagittal line tilt angle of each of the incident surface and the exit surface of the first imaging optical element 5a is appropriately set so as to suppress a deterioration of optical performance.

Thereby, the opposite side ghost can be reduced with achieving a reduction in cost in the light scanning apparatus according to the embodiment which employs an in-deflection-plane scanning and a non-uniform scanning properties in order to achieve a reduction in thickness and a reduction in size.

Although the shape of the first imaging optical element 5a has been described above, the above discussion can be similarly applied to the second imaging optical element 5b.

Values of Inequalities in the light scanning apparatuses according to the first to third embodiments are shown in the following Table 8.

TABLE 8

| | | First | Second | Third |
|---|---|---|---|---|
| | Unit | embodiment | embodiment | embodiment |
| d1 | mm | 13.8 | 13.8 | 13.8 |
| d2 | mm | 105.2 | 105.2 | 105.2 |
| F | | −0.51 | −1.10 | 0.25 |
| β | | −5.98 | −5.60 | −6.63 |
| Ri | mm | 30.55 | −163.20 | 10.99 |
| Ro | mm | −10.00 | −8.00 | −18.13 |
| Sagittal line tilt angle on optical | degrees | −4.0 | −5.1 | −6.8 |
| axis of incident surface of first | | | | |
| imaging optical element 5a | | | | |
| Sagittal line tilt angle on optical | degrees | −4.5 | −5.7 | −10.1 |
| axis of exit surface of first | | | | |
| imaging optical element 5a | | | | |

| | | | |
|---|---|---|---|
| Inequality (4): 0.09 < d1/(d1 + d2) < 0.14 | 0.12 | 0.12 | 0.12 |
| Inequality (5): −2.7 ≤ F < 1.0 | −0.51 | −1.10 | 0.25 |
| Inequality (5a): −1.7 ≤ F ≤ 0.7 | | | |
| Inequality (5b): −1.15 ≤ F ≤ 0.56 | | | |
| Inequality (7): −7.00 ≤ β ≤ −5.35 | −5.98 | −5.60 | −6.63 |

According to the disclosure, it is possible to provide a light scanning apparatus capable of easily suppressing ghost light from reaching a surface to be scanned.

### [Image Forming Apparatus]

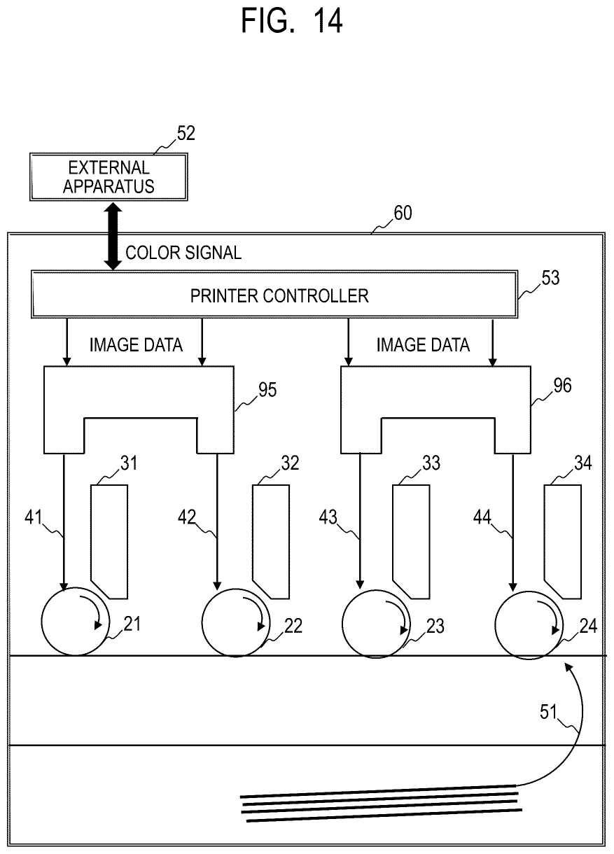

FIG. 14 shows a sub-scanning cross sectional view of a main part of an image forming apparatus 60 in which the light scanning apparatus according to any one of the first to third embodiments is mounted.

The image forming apparatus 60 is a color image forming apparatus that records image information on each of four photosensitive drums, for example.

The image forming apparatus 60 includes photosensitive drums 21, 22, 23 and 24, developing units 31, 32, 33 and 34, a conveying belt 51, a printer controller 53, and light scanning apparatuses 95 and 96 according to any one of the first to third embodiments.

Color signals of R (red), G (green), and B (blue) output from an external apparatus 52 such as a personal computer are input to the image forming apparatus 60.

The input color signals are converted into image data (screen patterns) of C (cyan), M (magenta), Y (yellow), and Bk (black) by the printer controller 53 provided in the image forming apparatus 60.

Next, the converted image data is input to the light scanning apparatuses 95 and 96, and light beams 41, 42, 43 and 44 modulated according to the input image data are emitted from the light scanning apparatuses 95 and 96.

Photosensitive surfaces of the photosensitive drums 21, 22, 23 and 24 are scanned in the main scanning direction by the emitted light beams 41, 42, 43 and 44, respectively.

The photosensitive surfaces of the photosensitive drums 21, 22, 23 and 24 are uniformly charged by charging units (not shown) before being irradiated with the light beams 41, 42, 43 and 44, respectively.

Then, the light beams 41, 42, 43 and 44 irradiate the uniformly charged photosensitive surfaces of the photosensitive drums 21, 22, 23 and 24, respectively, thereby voltages of only the irradiated portions are lowered.

In this way, voltage distributions formed on the photosensitive surfaces of the photosensitive drums 21, 22, 23 and 24 become latent images (electrostatic latent images).

Next, the formed latent images are developed as toner images by the developing units 31, 32, 33 and 34 arranged so as to abut on the photosensitive drums 21, 22, 23 and 24, respectively.

The toner images developed by the developing units 31, 32, 33 and 34 are transferred in a superimposed manner onto a sheet (transferred material) (not shown) conveyed on the conveying belt 51 by transferring rollers (transferring units) (not shown) arranged so as to face the photosensitive drums 21, 22, 23 and 24. Thereby, one full-color image is formed.

The sheet on which the unfixed toner image is transferred as described above is further conveyed to a fixing unit (not shown) provided behind the photosensitive drums 21, 22, 23 and 24.

Next, the sheet conveyed to the fixing unit is heated with being pressed at a pressure contact portion between a fixing roller and a pressurizing roller of the fixing unit, so that the toner image on the sheet is fixed, and the fixed sheet is discharged to outside of the image forming apparatus 60 by a sheet discharging roller (not shown).

The image forming apparatus 60 records image signals (image information) in parallel on the respective photosensitive surfaces of the photosensitive drums 21, 22, 23 and 24 of C (cyan), M (magenta), Y (yellow) and Bk (black) by using the two light scanning apparatuses 95 and 96. Thereby, a color image is printed at a high speed.

As the external apparatus 52, a color image reading apparatus including a CCD sensor may be used, for example. In this case, the color image reading apparatus and the image forming apparatus 60 form a color digital copying machine.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-003304, filed Jan. 9, 2025, which is hereby incorporated by reference herein in its entirety.

What is claimed is:

1. An apparatus, comprising:
a deflecting unit including first and second deflecting surfaces configured to deflect first and second light fluxes to scan first and second surfaces in a main scanning direction, respectively; and
first and second optical systems configured to guide the first and second light fluxes deflected by the first and second deflecting surfaces to the first and second surfaces, respectively,
wherein scanning speeds of the first light flux at an on-axis image height and an outermost off-axis image height on the first surface are different from each other, and
wherein the first optical system includes a first optical element in which a sagittal line tilt amount on at least one of an incident surface and an exit surface thereof changes in a main scanning direction.

2. The apparatus according to claim 1, wherein the following Inequality is satisfied:
$$- 2.7 \leq \frac{{R}_{o} + {R}_{i}}{{R}_{o} - {R}_{i}} < 1.$$
where Rᵢ and Rₒ represent curvature radii of sagittal line on an optical axis of the incident surface and the exit surface of the first optical element, respectively.

3. The apparatus according to claim 1, wherein the sagittal line tilt amount changes in the main scanning direction on any of the incident surface and the exit surface of the first optical element.

4. The apparatus according to claim 1, wherein an absolute value of the sagittal line tilt amount changes in the main scanning direction so as to be largest on an optical axis on at least one of the incident surface and the exit surface of the first optical element.

5. The apparatus according to claim 1, wherein the following Inequality is satisfied:
$$0.09 < \frac{{d}_{1}}{{d}_{1} + {d}_{2}} < 0.14$$
where d₁ and d₂ represent a distance between an on-axis deflection point on the first deflecting surface and the incident surface, and a distance between the exit surface and the first surface on an optical path of a principal ray of an on-axis light flux, respectively.

6. The apparatus according to claim 1, wherein the following Inequality is satisfied:
−7.00≤β≤−5.35
where β represents a magnification in a sub-scanning cross section of the first optical system.

7. The apparatus according to claim 1, further comprising a third optical system configured to cause the first light flux to be incident on the deflecting unit while condensing the first light flux in a sub-scanning cross section.

8. The apparatus according to claim 1, wherein at least one of the incident surface and the exit surface of the first optical element has a fine structure or an antireflection film.

9. The apparatus according to claim 1, wherein an optical axis of each of the first and second optical systems is in a predetermined plane parallel to a main scanning cross section.

10. The apparatus according to claim 1, further comprising a third optical system configured to cause the first light flux to be incident on the deflecting unit,
wherein an optical axis of each of the third optical system and the first optical system is in a predetermined plane parallel to a main scanning cross section.

11. The apparatus according to claim 1, wherein an outermost off-axis scanning speed of the first light flux at the outermost off-axis image height is higher than an on-axis scanning speed of the first light flux at the on-axis image height on the first surface.

12. The apparatus according to claim 11, wherein the following Inequality is satisfied:
1.05≤P≤2.00
where P represents a value of a ratio of the outermost off-axis scanning speed to the on-axis scanning speed.

13. The apparatus according to claim 1,
wherein scanning speeds of the second light flux at an on-axis image height and an outermost off-axis image height on the second surface are different from each other, and
wherein the second optical system consists of a second optical element in which a sagittal line tilt amount on at least one of an incident surface and an exit surface thereof changes in the main scanning direction.

14. The apparatus according to claim 1, wherein the first optical element is configured to guide the first light flux deflected by the first deflecting surface to an image height between outermost off-axis image heights on the first surface.

15. The apparatus according to claim 1, wherein the first and second surfaces are arranged on sides opposite to each other with respect to a plane including a rotation axis of the deflecting unit and perpendicular to an optical axis of the first optical system.

16. An apparatus, comprising:
a deflecting unit configured to deflect a first light flux to scan a first surface in a main scanning direction; and
a first optical system configured to guide the first light flux deflected by the deflecting unit to the first surface, the first optical system consisting of a first optical element,
wherein scanning speeds of the first light flux at an on-axis image height and an outermost off-axis image height on the first surface are different from each other, and
wherein a sagittal line tilt amount changes in a main scanning direction on at least one of an incident surface and an exit surface of the first optical element.

17. An image forming apparatus, comprising:
the apparatus according to claim 1; and
a developing unit configured to develop electrostatic latent images formed on the first and second surfaces to be scanned by the apparatus.

18. The image forming apparatus according to claim 17, wherein in the apparatus, the sagittal line tilt amount changes in the main scanning direction on any of the incident surface and the exit surface of the first optical element.

19. An image forming apparatus, comprising:
the apparatus according to claim 1; and
a controller configured to convert a signal output from an external apparatus into image data to input the image data to the apparatus.

20. The image forming apparatus according to claim 19, wherein in the apparatus, the sagittal line tilt amount changes in the main scanning direction on any of the incident surface and the exit surface of the first optical element.
